(19) United States
(12) Patent Application Publication
(10) Pub. No.: US 2010/0042493 A1
(43) Pub. Date: Feb. 18, 2010

(54) ADVERTISING DISTRIBUTION SYSTEM, ADVERTISING EFFECTIVENESS VALIDATION SERVER, ADVERTISING DISTRIBUTION METHOD, AND ADVERTISING EFFECTIVENESS VALIDATION PROGRAM

(76) Inventors: Yuichi Nino, Tokyo (JP); Yusuke Konishi, Tokyo (JP); Teruki Sukenari, Tokyo (JP); Toshiyasu Nakao, Tokyo (JP); Jun Noda, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/450,156

(22) PCT Filed: Mar. 11, 2008
(86) PCT No.: PCT/JP2008/054341

§ 371 Date: Sep. 14, 2009

(30) Foreign Application Priority Data
Mar. 19, 2007 (JP) 2007-071126

(51) Int. Cl. G06Q 30/00

(52) U.S. Cl. 705/14.45; 705/14.41

(57) ABSTRACT

It is ensured that advertising information can be distributed and advertising effectiveness can be validated without increasing any burden on the store side. A distribution server 1 gives an advertisement ID and advertisement position information to the advertising information to distribute it to a user portable terminal 3. The user portable terminal 3 automatically judges whether or not a user visits the store on the basis of terminal position information detected by a sensor 32 and the advertisement position information given to the advertising information. When judging that the user has visited the store, the user portable terminal 3 extracts the user ID and the advertisement ID given to the advertising information and transmits them to an effectiveness validation server 2. The effectiveness validation server 2 executes a processing for validating the advertising effectiveness on the basis of the received user ID and advertisement ID and computes a point given to the user and an advertising fee charged to the advertiser according to the result of the validation of the advertising effectiveness.

### TECHNICAL FIELD

The present invention relates to advertising distribution system and advertising distribution method of store-visit-guaranteed type in which advertising information is distributed and advertising effectiveness is validated based on information whether or not a user has visited a store. Furthermore, the present invention relates to an advertising effectiveness validation server and an advertising effectiveness validation program that the advertising effectiveness is validated based on information whether or not a user has visited a store. The present invention also relates to a user terminal included in the advertising distribution system, and a program product for a user terminal mounted in the user terminal.

### BACKGROUND ART

In a related art, a system has been designed in which when advertising information is distributed to a portable terminal of a user through the Internet, an advertising fee for an advertiser is determined based on the number of times that the user who received distribution of the advertising information actually visits the store. For example, a patent document 1 discloses a technique of adding a point to a user based on the times that the user has visited a store.

### [Patent Document 1]

### Japanese Unexamined Patent Application Publication No. 2002-150117 (0033-0048, FIGS. 6 to 9)

### DISCLOSURE OF INVENTION

### Technical Problems

FIG. 14 is a block diagram showing a configuration example of an advertising distribution system employing the configuration disclosed in the patent document 1 and the like. In the example shown in FIG. 14, the advertising distribution system includes a distribution server 91 and an effectiveness validation server 92 managed by an advertisement distribution company, and a user portable terminal device 93 used by a user.

Further, the distribution server 91 includes an advertisement ID giving unit 911 that gives an advertisement ID to the advertising information. Further, the effectiveness validation server 92 includes an advertisement effect measuring unit 921 that measures the effect produced by the advertisement, a point calculating unit 922 that gives a point to a user, and an advertising fee calculating unit 923 that calculates the advertising fee charged to an advertiser. Further, a store visit information input unit 951 is provided in a store to input store visit information indicating the visit of the user by a store terminal or the like (point card reader, for example) arranged in the store.

In the advertising distribution system shown in FIG. 14, the distribution server 91 gives the advertisement ID for identifying advertising information to advertising information provided by an advertiser, and distributes the advertising information to which the advertisement ID is given to the user portable terminal 93. Then, when a user who has received the advertising information visits a store with the user portable terminal 93, a store personnel operates the store visit information input unit 951 and indicates to input the store ID known only by a person in the store. Then, the store visit information input unit 951 transmits the advertisement ID and the user ID that correspond to the user portable terminal 93 to the effectiveness validation server 92 according to the operation by the store personnel in the store.

The advertisement effect measuring unit 921 of the effectiveness validation server 92 counts the number of visits to the store for each advertising information, and the advertising fee calculating unit 923 calculates an advertising fee based on the count result to charge the advertiser for the fee. Further, the point calculating unit 922 counts the number of visits to the store for each user to give a point to each user in accordance with the number of visits to the store.

In the advertising distribution system shown in FIG. 14, it is possible to give points to the user who has visited the store based on the number of visits to the store or the like and to charge the advertiser for the advertising fee based on the number of visits to the store for each advertisement. However, this technique requires input operation of the store ID by the store personnel with the store terminal or the like, which puts great troublesome operation on the store. Furthermore, as there is a need to train the store personnel in order to provide the advertising distribution service, the operation burden for the store personnel increases as the number of users increases.

The present invention aims to provide an advertising distribution system, an advertising effectiveness validation server, a user terminal, an advertising distribution method, an advertisement effectiveness guarantee program, and a program product for a user terminal that enable to distribute advertising information and validate advertising effectiveness without increasing any troublesome operation on the store side.

### Technical Solution

An advertising distribution system according to the present invention is an advertising distribution system that distributes advertising information and validates advertising effectiveness, including an advertising effectiveness validation server (effectiveness validation server 2, for example) that validates the advertising effectiveness, and a user terminal (user portable terminal 3, for example), in which the user terminal includes a terminal position calculating means (realized by a sensor 32, for example) that obtains terminal position information indicating position of the user terminal, a store visit judging means (realized by store visit detecting unit 31, for example) that judges whether or not a user has visited a store on a basis of the terminal position information obtained by the terminal position calculating means, and a store visit information transmitting means (realized by store visit detecting unit 31, for example) that transmits store visit information (user ID and advertisement ID, for example) indicating that the user has visited the store to the advertising effectiveness validation server through communication network upon judgment by the store visit judging means that the user has visited the store, and the advertising effectiveness validation server includes an advertising effectiveness validating means (realized by advertisement effect measuring unit 21, for example) that validates the advertising effectiveness based on the store visit information received from the user terminal.

The advertising distribution system may further include an advertisement distribution server (distribution server 1, for example) that distributes advertising information, in which the advertisement distribution server includes an advertisement position information adding means (realized by positional information giving unit 12, for example) that adds advertisement position information indicating position regarding advertising information to the advertising information, and an advertising information transmitting means (realized by advertisement ID giving unit 11, for example) that transmits advertising information to which the advertisement position information is added by the advertisement position information adding means to the user terminal through communication network, and the store visit judging means judges whether the user has visited the user based on the terminal position information obtained by the terminal position calculating means and the advertisement position information added to the advertising information received from the advertisement distribution server.

In the advertising distribution system, the advertisement distribution server may include an advertisement ID adding means (realized by advertisement ID giving unit 11, for example) that adds an advertisement ID for identifying advertising information to the advertising information, the advertising information transmitting means transmits the advertising information to which the advertisement ID is added by the advertisement ID adding means to the user terminal through communication network, the store visit information transmitting means transmits store visit information including the advertisement ID added to the advertising information received from the advertisement distribution server to the advertising effectiveness validation server through communication network, the advertising effectiveness validating means generates information including the number of customers visiting the store as advertising effect information indicating the advertising effectiveness by counting the number of times of reception of the advertisement ID from the user terminal, and the advertising effectiveness validation server includes an advertising fee calculating means (realized by advertising fee calculating unit 23, for example) that calculates an advertising fee charged to an advertiser according to the number of customers visiting the store shown in the advertising effect information generated by the advertising effectiveness validating means.

Further, in the advertising distribution system, the store visit information transmitting means transmits store visit information including a user ID for identifying a user to the advertising effectiveness validation server through communication network, the advertising effectiveness validating means generates information including the number of visits to the store by the user as the advertising effect information indicating the advertising effectiveness by counting the number of times of reception of the user ID from the user terminal, and the advertising effectiveness validation server includes a point calculating means (realized by point calculating unit 22, for example) that calculates a point given to the user in accordance with the number of visits to the store shown in the advertising effect information generated by the advertising effectiveness validating means.

Furthermore, in the advertising distribution system, the store visit information transmitting means transmits store visit information including position calculating means identifying information (sensor information, for example) that is capable of identifying the terminal position calculating means to the advertising effectiveness validation server through communication network, the advertising effectiveness validation server includes a reliability judging means (realized by behavior validating unit 211, for example) that judges reliability of positional calculation using the terminal position calculating means based on the position calculating means identifying information received by the user terminal, and the advertising effectiveness validating means validates the advertising effectiveness based on judgment by the reliability judging means that the reliability of the positional calculation using the terminal position calculating means is high.

Further, the advertising distribution system may include a communication carrier server (terminal monitoring server 4, for example) that is managed by a communication carrier, in which the communication carrier server includes a terminal position acquiring means (realized by store visit detecting unit 41, for example) that acquires the terminal position information, a carrier-side store visit judging means (realized by store visit detecting unit 41, for example) that judges whether the user has visited the store based on the terminal position information acquired by the terminal position acquiring means, and a carrier-side store visit information transmitting means (realized by store visit detecting unit 41, for example) that transmits store visit information indicating that the user has visited the store to the advertising effectiveness validation server through communication network based on the judgment by the carrier-side store visit judging means that the user has visited the store, and the advertising effectiveness validation server may include a carrier consideration calculating means (realized by position detecting consideration calculating unit 24, for example) that calculates consideration paid for the communication carrier based on a result of validation by the advertising effectiveness validating means.

Further, the advertising distribution system may include an advertisement distribution server (distribution server 1, for example) that distributes advertising information, and an affiliate terminal (affiliate user terminals 51 and 52, for example) that is used by an affiliate mediator (affiliate user, for example) that mediates the advertising information, in which the advertisement distribution server includes an affiliate ID adding means (realized by affiliate ID giving unit 14, for example) that adds an affiliate ID for identifying the affiliate mediator to the advertising information, and an advertising information transmitting means (realized by affiliate ID giving unit 14, for example) that transmits the advertising information to which the affiliate ID is added by the affiliate ID adding means to the user terminal through communication network, the affiliate terminal includes an advertising information transferring means (realized by CPU and network interface unit included in affiliate user terminals 51, 52, for example) that transfers the advertising information received from the advertisement distribution server to the user terminal, the store visit information transmitting means transmits the store visit information including the affiliate ID added to the advertising information received from the affiliate terminal to the advertising effectiveness validation server through communication network, the advertising effectiveness validating means generates information including actual number of visits to the store by the user in response to introduction by the affiliate mediator as the advertising effect information indicating the advertising effectiveness by counting the number of times of reception of the affiliate ID from the user terminal, and the advertising effectiveness validation server includes an affiliate consideration calculating means (realized by advertising consideration calculating unit 25, for example) that calculates consideration paid for the affiliate mediator in accordance with the actual number of visits to the store shown in the advertising effect information generated by the advertising effectiveness validating means.

Further, in the advertising distribution system, the affiliate terminal may include an affiliate terminal position calculating means (realized by store visit detecting units 511, 512, for example) that obtains affiliate terminal position information indicating position of the affiliate terminal, an affiliate store visit judging means (realized by store visit detecting units 511, 512, for example) that judges whether the affiliate mediator has visited the store based on the affiliate terminal position information obtained by the affiliate terminal position calculating means, and an affiliate store visit information transmitting means (realized by store visit detecting units 511, 512, for example) that transmits the affiliate store visit information indicating that the affiliate mediator has visited the store to the advertising effectiveness validation server through communication network based on the judgment by the affiliate store visit judging means that the affiliate mediator has visited the store, the advertising effectiveness validation server includes an accompany judging means (realized by company detecting unit 212, for example) that judges whether the affiliate mediator and the user have visited the store together based on the affiliate terminal information received from the affiliate terminal and the store visit information received from the user terminal, and the affiliate consideration calculating means may calculate consideration paid for the affiliate mediator based on a judgment result of the accompany judging means.

An advertising effectiveness validation server according to the present invention is an advertising effectiveness validation server (effectiveness validation server 2, for example) that validates advertising effectiveness in an advertising distribution system that distributes advertising information, the advertising effectiveness validation server including a position calculating means identifying information receiving means (realized by advertisement effect measuring unit 21A, for example) that receives store visit information including position calculating means identifying information that is capable of identifying terminal position calculating means used by a user terminal for calculating a position from the user terminal through communication network, a reliability judging means (realized by behavior validating unit 211, for example) that judges reliability of positional calculation using the terminal position calculating means by the user terminal based on the position calculating means identifying information received by the position calculating means identifying information receiving means, and an advertising effectiveness validating means (realized by advertisement effect measuring unit 21A, for example) that validates the advertising effectiveness based on judgment by the reliability judging means that the reliability of the position calculation with the terminal position calculating means is high.

Further, the advertising effectiveness validation server may include a carrier-side store visit information receiving means (realized by advertisement effect measuring unit 21B, for example) that receives store visit information indicating that a user has visited a store from a communication carrier server (terminal monitoring server 4, for example) managed by a communication carrier through communication network, and a carrier consideration calculating means (realized by position detecting consideration calculating unit 24, for example) that calculates consideration paid for the communication carrier based on a result of validation of the advertising effectiveness validating means.

Further, the advertising effectiveness validation server may include a store visit information receiving means (realized by advertisement effect measuring unit 21C, for example) that receives store visit information including an affiliate ID for identifying an affiliate mediator that mediates advertising information from the user terminal through communication network, in which the advertising effectiveness validating means generates information including actual number of visits to the store by the user in response to introduction by the affiliate mediator as advertising effect information indicating the advertising effectiveness by counting the number of times of reception of the affiliate ID from the user terminal, and the advertising effectiveness validation server further includes an affiliate consideration calculating means that calculates consideration paid for the affiliate mediator in accordance with the actual number of visits to the store shown in the advertising effect information generated by the advertising effectiveness validating means.

Furthermore, the advertising effectiveness validation server may include an affiliate store visit information receiving means (realized by advertisement effect measuring unit 21, for example) that receives affiliate store visit information indicating that the affiliate mediator has visited the store through communication network from an affiliate terminal used by the affiliate mediator, and an accompany judging means (realized by company detecting unit 212, for example) that judges whether the affiliate mediator and the user have visited the store together based on the store visit information received from the user terminal and affiliate terminal information received from the affiliate terminal, in which the affiliate consideration calculating means calculates consideration paid for the affiliate mediator based on a judgment result by the accompany judging means.

A user terminal of an advertising distribution system according to the present invention is a user terminal (user portable terminal 3, for example) that distributes advertising information and validates advertising effectiveness, the user terminal including a terminal position calculating means (realized by sensor 32, for example) that obtains terminal position information that indicates position of the user terminal, a store visit judging means (realized by store visit detecting unit 31, for example) that judges whether a user has visited a store on a basis of the terminal position information obtained by the terminal position calculating means, and a store visit information transmitting means (realized by store visit detecting unit 31, for example) that transmits store visit information indicating that the user has visited the store to an advertising effectiveness validation server through communication network upon judgment by the store visit judging means that the user has visited the store.

An advertising distribution method according to the present invention is an advertising distribution method that distributes advertising information and validates advertising effectiveness, the method including a terminal position calculating step that obtains terminal position information indicating position of a user terminal by the user terminal, a store visit judging step that judges by the user terminal whether a user has visited a store on a basis of the terminal position information that is obtained, a store visit information transmitting step that transmits store visit information indicating that the user has visited the store by the user terminal to an advertising effectiveness validation server through communication network upon judgment that the user has visited the store, and an advertising effectiveness validating step that validates the advertising effectiveness by the advertising effectiveness validation server that validates the advertising effectiveness based on the store visit information received from the user terminal.

Further, in the advertising distribution method, the user terminal transmits store visit information including position calculating means identifying information that is capable of identifying a terminal position calculating means used by the user terminal for calculating the position to the advertising effectiveness validation server through communication network in the store visit information transmitting step, the advertising effectiveness validation server includes a reliability judging step that judges reliability of positional calculation using the terminal position calculating means based on the position calculating means identifying information received from the user terminal, and the advertising effectiveness validation server validates the advertising effectiveness based on judgment in the advertising effectiveness validating step that the reliability of the positional calculation using the terminal position calculating means is high.

The advertising distribution method may further include a terminal position acquiring step in which a communication carrier server managed by a communication carrier acquires the terminal position information, a carrier-side store visit judging step in which the communication carrier server judges whether the user has visited the store based on the terminal position information that is acquired, a carrier-side store visit information transmitting step in which the communication carrier server transmits store visit information indicating visit of the user to the advertising effectiveness validation server through communication network based on the judgment that the user has visited the store, and a carrier consideration calculating step in which the advertising effectiveness validation server calculates consideration paid for the communication carrier based on a result of validation of the advertising effectiveness.

The advertising distribution method may further include an affiliate ID adding step in which an advertisement distribution server distributing advertising information adds an affiliate ID for identifying an affiliate mediator that mediates the advertising information to advertising information, an advertising information transmitting step in which the advertisement distribution server transmits the advertising information to which the affiliate ID is added to the user terminal through communication network, an advertising information transferring step in which an affiliate terminal used by the affiliate mediator transfers the advertising information received from the advertisement distribution server to the user terminal, in which the user terminal transmits the store visit information including the affiliate ID added to the advertising information received from the affiliate terminal to the advertising effectiveness validation server through communication network in the store visit information transmitting step, and the advertising effectiveness validation server generates information including actual number of visits to the store by the user in response to introduction by the affiliate mediator as the advertising effect information indicating the advertising effectiveness by counting the number of times of reception of the affiliate ID from the user terminal in the advertising effectiveness validating step, the advertising distribution method further including an affiliate consideration calculating step in which the advertising effectiveness validation server calculates consideration paid for the affiliate mediator in accordance with the actual number of visits to the store shown in the advertising effect information that is generated.

The advertising distribution method may further include an affiliate terminal position calculating step in which the affiliate terminal obtains affiliate terminal position information indicating position of the affiliate terminal, an affiliate store visit judging step in which the affiliate terminal judges based on the obtained affiliate terminal position information whether the affiliate mediator has visited the store, an affiliate store visit information transmitting step in which the affiliate terminal transmits affiliate store visit information indicating the visit of the affiliate mediator to the advertising effectiveness validation server through communication network based on the judgment that the affiliate mediator has visited the store, and an accompany judging step in which the advertising effectiveness validation server judges based on the store visit information received from the user terminal and the affiliate terminal information received from the affiliate terminal whether the affiliate mediator and the user have visited the store together, in which the advertising effectiveness validation server calculates consideration paid for the affiliate mediator based on a judgment result whether the user and the affiliate mediator have visited together in the affiliate consideration calculating step.

An advertising effectiveness validation program product according to the present invention is an advertising effectiveness validation program product for validating advertising effectiveness in an advertising distribution system that distributes advertising information, the program product causing a computer to implement a position calculating means identifying information reception processing that receives store visit information including position calculating means identifying information that is capable of identifying terminal position calculating means used by a user terminal for calculating position from the user terminal through communication network, a reliability judgment processing that judges reliability of positional calculation using the terminal position calculating means by the user terminal based on the position calculating means identifying information that is received, and an advertising effectiveness validation processing that validates the advertising effectiveness based on judgment that the reliability of the positional calculation using the terminal position calculating means is high.

The advertising effectiveness validation program product may be the one that causes the computer to implement a carrier-side store visit information reception processing that receives store visit information indicating visit of the user from a communication carrier server managed by a communication carrier through communication network, and a carrier consideration calculation processing that calculates consideration paid for the communication carrier based on a result of validation of the advertising effectiveness.

Further, the advertising effectiveness validation program product may cause the computer to implement a store visit information reception processing that receives store visit information including an affiliate ID for identifying an affiliate mediator that mediates advertising information from the user terminal through communication network, a processing that generates information including actual number of visits to the store by the user in response to introduction by the affiliate mediator as advertising effect information indicating the advertising effectiveness by counting the number of times of reception of the affiliate ID from the user terminal in the advertising effectiveness validation processing, and an affiliate consideration calculation processing that calculates consideration paid for the affiliate mediator in accordance with the actual number of visits to the store shown in the advertising effect information that is generated.

Furthermore, the advertising effectiveness validation program product may cause the computer to implement an affiliate store visit information reception processing that receives affiliate store visit information indicating the visit of the affiliate mediator from an affiliate terminal used by the affiliate mediator through communication network, a company judgment processing that judges based on the store visit information received from the user terminal and affiliate terminal information received from the affiliate terminal whether the affiliate mediator and the user have visited the store together, and a processing that calculates consideration paid for the affiliate mediator based on a judgment result whether the user and the affiliate mediator have visited the store together in the affiliate consideration calculation processing.

A program product for a user terminal according to the present invention is a program product for a user terminal mounted in a user terminal of an advertising distribution system that distributes advertising information and validates advertising effectiveness, the program product causing a computer to implement a terminal position calculation processing that obtains terminal position information indicating position of the user terminal, a store visit judgment processing that judges whether a user has visited a store on a basis of the terminal position information that is obtained, and a store visit information transmission processing that transmits store visit information indicating visit of the user to an advertising effectiveness validation server through communication network upon judgment that the user has visited the store.

### ADVANTAGEOUS EFFECTS

According to the present invention, the user terminal automatically detects whether or not the user has visited the store on a basis of the terminal position information, and transmits the store visit information to the advertising effectiveness validation server upon detection of the user visit. Then, the advertising effectiveness validation server validates the advertising effectiveness for distributing the advertising information based on the store visit information received from the user terminal. As such, there is no need to perform special operation by a store personnel and to arrange a store terminal such as a point card reader or the like in the store to detect the user visit. Accordingly, it is possible to distribute the advertising information and to validate the advertising effectiveness without increasing the burden on the store side.

Further, according to the present invention, as the user terminal transmits the store visit information including the position calculating means identifying information that is capable of identifying the terminal position calculating means and the advertising effectiveness validation server judges the reliability of the position detection by the terminal position calculating means based on the position calculating means identifying information, misbehaviors can be prevented such as acquiring points by improperly using the terminal position calculating means.

Furthermore, according to the present invention, as the communication carrier server judges whether the user has visited the store and transmits the store visit information to the advertising effectiveness validation server, a new business model can be realized in which the advertisement distribution company pays consideration for providing the information by position detection for the communication carrier.

Still further, according to the present invention, as the affiliate terminal used by the affiliate mediator is provided and the user terminal transmits the store visit information including the affiliate ID to the advertising effectiveness validation server, it is possible to realize a new business model in which consideration is paid for the affiliate transferrer in accordance with the actual visit to the store by the user. Furthermore, there is no need to perform special operation by a store personnel and to install a store terminal such as a point card reader or the like in the store to realize the affiliate business. Accordingly, it is possible to realize affiliate business without increasing the burden on the store side.

Furthermore, according to the present invention, as the affiliate terminal automatically detects whether the affiliate mediator has visited the store based on the affiliate terminal position information and the advertising effectiveness validation server judges whether the affiliate mediator and the user have visited the store together, a business model may be realized in which consideration is paid for the affiliate user by highly evaluating that the affiliate mediator and the user have visited the store together compared with a case in which only the end user visits the store. Further, there is no need to perform special operation by a store personnel and to install a store terminal such as a point card reader or the like in the store to realize the affiliate business. Accordingly, it is possible to realize affiliate business without increasing the burden on the store side.

### BRIEF DESCRIPTION OF DRAWINGS

FIG. 1A is a block diagram showing one example of the configuration of a store-visit-guaranteed advertising distribution system according to the present invention;

FIG. 1B is a block diagram showing one example of the configuration of the store-visit-guaranteed advertising distribution system in more detail according to the present invention;

FIG. 2A is an explanatory diagram showing an example of advertising effect information stored in an advertisement effect database;

FIG. 2B is an explanatory diagram showing an example of the advertising effect information stored in the advertisement effect database;

FIG. 3 is a flow chart showing one example of the processing in which the advertising distribution system distributes advertising information and validates advertising effectiveness;

FIG. 4 is a block diagram showing a configuration example of a store-visit-guaranteed advertising distribution system according to a second embodiment;

FIG. 5 is a flow chart showing a processing example in which the advertising distribution system according to the second embodiment distributes the advertising information and validates the advertising effectiveness;

FIG. 6 is a block diagram showing a configuration example of a store-visit-guaranteed advertising distribution system according to a third embodiment;

FIG. 7 is a flow chart showing a processing example in which the advertising distribution system according to the third embodiment distributes the advertising information and validates the advertising effectiveness;

FIG. 8 is a block diagram showing a configuration example of a store-visit-guaranteed advertising distribution system according to a fourth embodiment;

FIG. 9 is an explanatory diagram showing another example of advertising effect information stored in the advertisement effect database;

FIG. 10 is a flow chart showing a processing example in which the advertising distribution system according to the fourth embodiment distributes the advertising information and validates the advertising effectiveness;

FIG. 11 is a block diagram showing a configuration example of a store-visit-guaranteed advertising distribution system according to a fifth embodiment;

FIG. 12 is an explanatory diagram showing a further example of the advertising effect information stored in the advertisement effect database;

FIG. 13 is a flow chart showing a processing example in which the advertising distribution system according to the fifth embodiment distributes the advertising information and validates the advertising effectiveness; and

FIG. 14 is a block diagram showing a configuration example of an advertising distribution system.

### EXPLANATION OF REFERENCE

1 DISTRIBUTION SERVER
2 EFFECTIVENESS VALIDATION SERVER
3 USER PORTABLE TERMINAL
4 TERMINAL MONITORING SERVER
11 ADVERTISEMENT ID GIVING UNIT
12 POSITIONAL INFORMATION GIVING UNIT
13 ADVERTISING DISTRIBUTION INFORMATION TRANSMITTING UNIT
14 AFFILIATE ID GIVING UNIT
21, 21A, 21B, 21C ADVERTISEMENT EFFECT MEASURING UNIT
22 POINT CALCULATING UNIT
23 ADVERTISING FEE CALCULATING UNIT
24 POSITION DETECTING CONSIDERATION CALCULATING UNIT
25 ADVERTISING CONSIDERATION CALCULATING UNIT
26, 26B, 26C, 26D ADVERTISEMENT EFFECT DATABASE
27 SENSOR INFORMATION DATABASE
31, 31A STORE VISIT DETECTING UNIT
32 SENSOR
33 TERMINAL POSITION CALCULATING UNIT
34 STORE VISIT INFORMATION TRANSMITTING UNIT
41 STORE VISIT DETECTING UNIT
51, 52 AFFILIATE USER TERMINAL
211 BEHAVIOR VALIDATING UNIT
212 COMPANY DETECTING UNIT
511, 512 STORE VISIT DETECTING UNIT

### BEST MODES FOR CARRYING OUT THE INVENTION

### First Embodiment

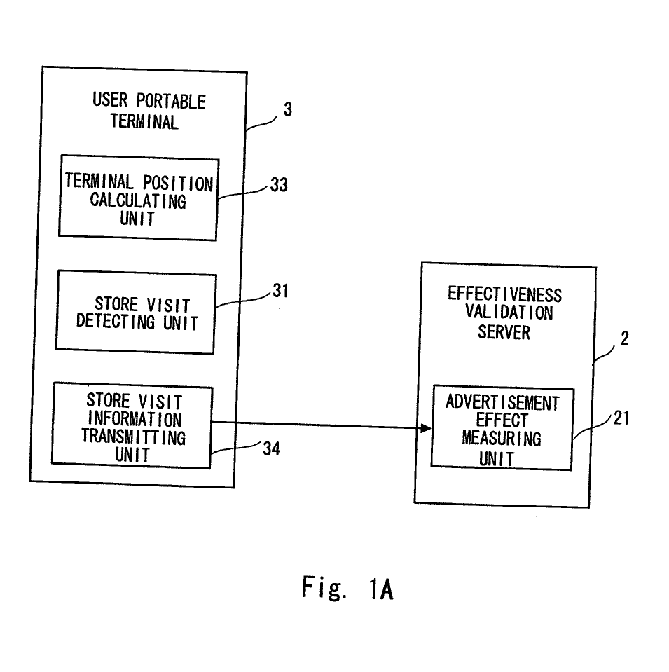

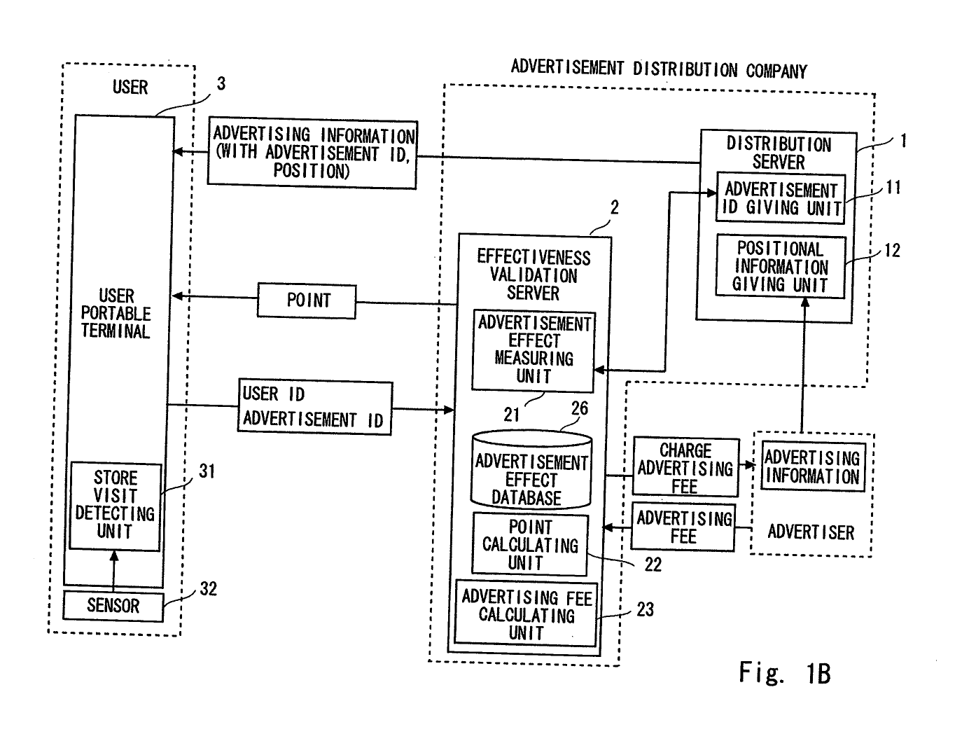

Hereinafter, the first embodiment of the present invention will be described with reference to the drawings. FIG. 1A is a block diagram showing one example of the configuration of a store-visit-guaranteed advertising distribution system according to the present invention. The advertising distribution system is an advertising distribution system that distributes advertising information and validates advertising effectiveness. The advertising distribution system includes an effectiveness validation server 2 that validates the advertising effectiveness, and a user portable terminal 3. The user portable terminal 3 includes a terminal position calculating unit 33 that obtains terminal position information indicating position of the user portable terminal 3, a store visit detecting unit 31 that judges whether a user has visited a store based on the terminal position information obtained by the terminal position calculating unit 33, and a store visit information transmitting unit 34 that transmits store visit information indicating that the user has visited the store to the effectiveness validation server 2 through communication network upon judgment by the store visit detecting unit 31 that the user has visited the store. The terminal position calculating unit 33 is a sensor 32 as shown in FIG. 1B, for example. The effectiveness validation server 2 includes an advertisement effect measuring unit 21 that validates the advertising effectiveness based on the store visit information received from the user portable terminal 3. FIG. 1B is a block diagram showing one example of the configuration of the store-visit-guaranteed advertising distribution system in more detail according to the present invention. As shown in FIG. 1B, the advertising distribution system includes a distribution server 1, an effectiveness validation server 2, and a user portable terminal 3. Further, the distribution server 1, the effectiveness validation server 2, and the user portable terminal 3 are connected through communication network including the Internet, mobile communication network or the like.

The distribution server 1 is a server managed by an advertisement distribution company that provides an advertising distribution service, and more specifically, realized by an information processing apparatus such as a personal computer or the like that is operated in accordance with a program. Note that the advertisement distribution company may be an advertising agency, or may be an operator or a communication carrier that manages a search site capable of providing an advertising distribution service. As shown in FIG. 1B, the distribution server 1 includes an advertisement ID giving unit 11 and a positional information giving unit 12.

Specifically, the advertisement ID giving unit 11 is realized by a CPU operating according to a program and a network interface unit of an information processing apparatus. The advertisement ID giving unit 11 includes a function of giving the advertisement ID for identifying the advertising information to each advertising information provided by an advertiser. Further, the advertisement ID giving unit 11 includes a function of transmitting the advertising information to which the advertisement ID is given as add information to the user terminal 3 through communication network. Note that, in the first embodiment, the advertisement ID giving unit 11 transmits the advertising information to which positional information is added by the positional information giving unit 12 to the user portable terminal 3.

More specifically, the positional information giving unit 12 is realized by a CPU of the information processing apparatus that works based on a program. The positional information giving unit 12 includes a function of calculating the positional information in accordance with each advertising information (position of a store which is advertising target, for example) and giving the positional information to the advertising information as add information. Hereinafter, the positional information in accordance with each advertising information calculated by the positional information giving unit 12 is also referred to as advertisement position information.

For example, the positional information giving unit 12 gives the advertisement position information provided from the advertiser with the advertising information in advance to the advertising information. Further, for example, the positional information giving unit 12 extracts a character string indicating the address of the store from the advertising information as the advertisement position information by executing text analysis or the like.

Note that the positional information giving unit 12 may directly give the information indicating the address of the store or the like as the advertisement position information, or may convert the information into latitude and longitude as the advertisement position information. When calculating the latitude and longitude as the advertisement position information, the positional information giving unit 12 stores a correspondence table in which the address, and the latitude and longitude are made correspondent to each other in a storage device such as a hard disk drive or the like in advance, for example. Then, the latitude and the longitude that correspond to the character string indicating the address that is extracted by executing the text analysis or the like from the advertising information are extracted from the correspondence table, so as to output the latitude and longitude that are extracted as the advertisement position information.

The effectiveness validation server 2 is a server managed by an advertisement distribution company, and more specifically, realized by an information processing apparatus such as a personal computer. As shown in FIG. 1B, the effectiveness validation server 2 includes an advertisement effect measuring unit 21, an advertisement effect database 26, a point calculating unit 22, and an advertising fee calculating unit 23.

More specifically, the advertisement effect measuring unit 21 is realized by a CPU working along with a program and a network interface unit in the information processing apparatus. The advertisement effect measuring unit 21 includes a function of receiving the advertisement ID and the user ID for identifying the user from the user portable terminal 3 through communication network. Further, the advertisement effect measuring unit 21 includes a function of executing a processing of measuring the advertising effectiveness in response to the advertising information distribution based on the received user ID and the advertisement ID. Further, the advertisement effect measuring unit 21 includes a function of storing the advertising effect information indicating the measuring result of the advertisement effect in the advertisement effect database 26.

More specifically, the advertisement effect measuring unit 21 calculates the data indicating the number of customers who have visited the store as the advertising effect information by counting the number of times of reception of the advertisement ID. Further, the advertisement effect measuring unit 21 calculates the number of times that the user has visited the store or the number of stores that the user has visited as the advertising effect information by counting the number of times of reception of the user ID.

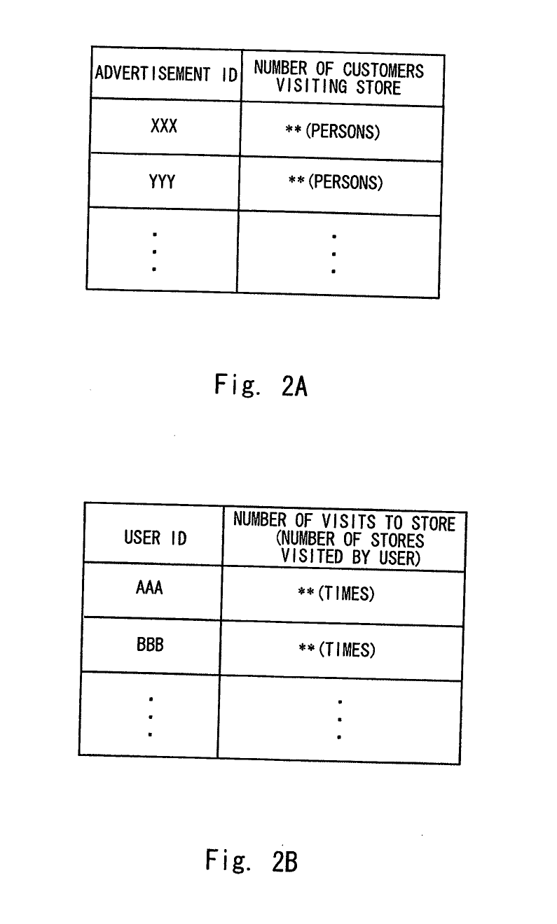

More specifically, the advertisement effect database 26 is realized by a database apparatus such as a magnetic disk apparatus, an optical disk apparatus or the like. The advertisement effect database 26 stores the advertising effect information obtained by the advertisement effect measuring unit 21. FIGS. 2A and 2B are explanatory diagrams showing an example of the advertising effect information stored in the advertisement effect database 26. The advertisement effect database 26 stores the number of customers visiting the store and the advertisement ID so as to be made correspondent to each other, as shown in FIG. 2A, for example. Further, the advertisement effect database 26 stores, as shown in FIG. 2B, the number of visits to the store by the user (the number of stores visited by the user) and the user ID so as to be made correspondent to each other, for example.

Specifically, the point calculating unit 22 is realized by a CPU of an information processing apparatus that works based on a program. The point calculating unit 22 includes a function of calculating the point given to the user based on the advertising effect information stored in the advertisement effect database 26. For example, the point calculating unit 22 calculates the point given to the user in accordance with the number of visits to the store by the user (the number of stores visited by the user) shown in the advertising effect information.

Specifically, the advertising fee calculating unit 23 is realized by a CPU of an information processing apparatus that works according to a program. The advertising fee calculating unit 23 includes a function of calculating the advertising fee charged to the advertiser based on the advertising effect information stored in the advertisement effect database 26. For example, the advertising fee calculating unit 23 calculates the advertising fee charged to the advertiser according to the number of customers visiting the store shown in the advertising effect information.

Although the first embodiment shows a case in which the distribution server 1 and the effectiveness validation server 2 are realized by separate servers, the distribution server 1 and the effectiveness validation server 2 may be realized with a common information processing apparatus.

The user portable terminal 3 is a terminal used by a user, and more specifically, a portable terminal such as a portable telephone operated according to a program. Further, for example, the user portable terminal 3 may be a terminal such as a PDA or the like as long as it can be carried by a user. Although FIG. 1B shows one user portable terminal 3, the advertising distribution system includes a plurality of user portable terminals 3.

As shown in FIG. 1B, the user portable terminal 3 includes a store visit detecting unit 31 and a sensor 32. Although FIG. 1B shows a case in which the sensor 32 is externally provided to the user portable terminal 3, the user portable terminal 3 may include the sensor 32 therein.

The sensor 32 includes a function of detecting the positional information of the user portable terminal 3 (latitude and longitude, for example). Hereinafter, the positional information of the user portable terminal 3 detected by the sensor 32 is also referred to as terminal position information. For example, when the user portable terminal 3 includes a GPS function, the sensor 32 is realized by the CPU of the user portable terminal 3 and a GPS receiver, and calculates the terminal position information based on the received GPS signal.

Further, for example, when the user portable terminal 3 includes a function of connection to a wireless LAN, the sensor 32 is realized by the CPU of the user portable terminal 3 and a transceiver for wireless LAN, and may calculate the terminal position information based on the positional information received from an access point (wireless base station) of the wireless LAN. Further, for example, the sensor 32 is realized by the CPU and the wireless transceiver included in the user portable terminal 3, and may calculate the terminal position information by receiving the positional information from each wireless base station using the position information service provided by a communication carrier. Further, for example, the sensor 32 may receive information capable of identifying the wireless base station (wireless area information capable of identifying the wireless area) from a plurality of wireless base stations to set the information as the terminal position information.

Specifically, the store visit detecting unit 31 is realized by a transceiver and a CPU of the portable terminal operated according to a program. The store visit detecting unit 31 includes a function of judging whether a user has visited the store based on the terminal position information detected by the sensor 32.

For example, the store visit detecting unit 31 receives the advertising information to which the advertisement ID and the advertisement position information (latitude and longitude) are added from the distribution server 1 through communication network, and stores the advertising information in a storing unit such as a memory. Further, upon reception of the terminal position information (latitude and longitude) from the sensor 32, the store visit detecting unit 31 judges whether the input position information matches the advertisement position information stored in the storing unit (or with a difference within a certain distance). If the input position information matches the advertisement position information (or with a difference within a certain distance), the store visit detecting unit 31 judges that the user has visited the store.

Further, for example, the store visit detecting unit 31 stores the information indicating the address of the store as the advertisement position information. When receiving a plurality of wireless area information as the terminal position information, the store visit detecting unit 31 may store a correspondence table in which the address and the wireless area information are made correspondent to each other in a storing unit such as a memory in advance. Then, for example, the store visit detecting unit 31 may be configured to extract the address that is correspondent to the received wireless area information from the correspondence table and judge whether or not the extracted address matches the address shown in the advertisement position information to judge whether or not the user has visited the store.

Furthermore, the store visit detecting unit 31 includes a function of transmitting the user ID and the advertisement ID to the effectiveness validation server 2 through communication network at detecting that the user has visited the store. For example, the store visit detecting unit 31 stores the advertising information received from the distribution server 1 and the user ID in a storing unit such as a memory, and transmits the advertisement ID added to the advertising information and the user ID to the effectiveness validation server 2 based on the judgment that the user has visited the store. Note that the store visit detecting unit 31 may transmit as the user ID the terminal number of the user portable terminal 3, an electronic mail address of the user or the like.

Further, for example, the user portable terminal 3 may attach an RFID tag as the sensor 32. In this case, the advertisement ID added to the advertising information received from the distribution server 1 and the user ID in the RFID tag, and a store terminal provided with an RFID reader may be arranged in the store side. Then, the store terminal may read out the advertisement ID and the user ID from the RFID tag attached to the user portable terminal 3 in accordance with the reading operation by the user, and transmit the advertisement ID and the user ID that are read out to the effectiveness validation server 2.

Note that, in the first embodiment, a storage device (not shown) of the effectiveness validation server 2 stores various programs for validating the advertising effectiveness for the advertising information distribution. Further, in the first embodiment, a storing unit (not shown) of the user portable terminal 3 stores various programs to detect whether the user has visited the store. For example, the storing unit of the user portable terminal 3 stores a store visit detection program which sets a computer to implement a terminal position calculation processing to obtain the terminal position information indicating the position of the user terminal, a store visit judgment processing to judge whether the user has visited the store based on the obtained terminal position information, and a store visit information transmission processing to transmit the store visit information indicating visit of the user to the advertising effectiveness validation server through communication network on the basis of the judgment of the user visit.

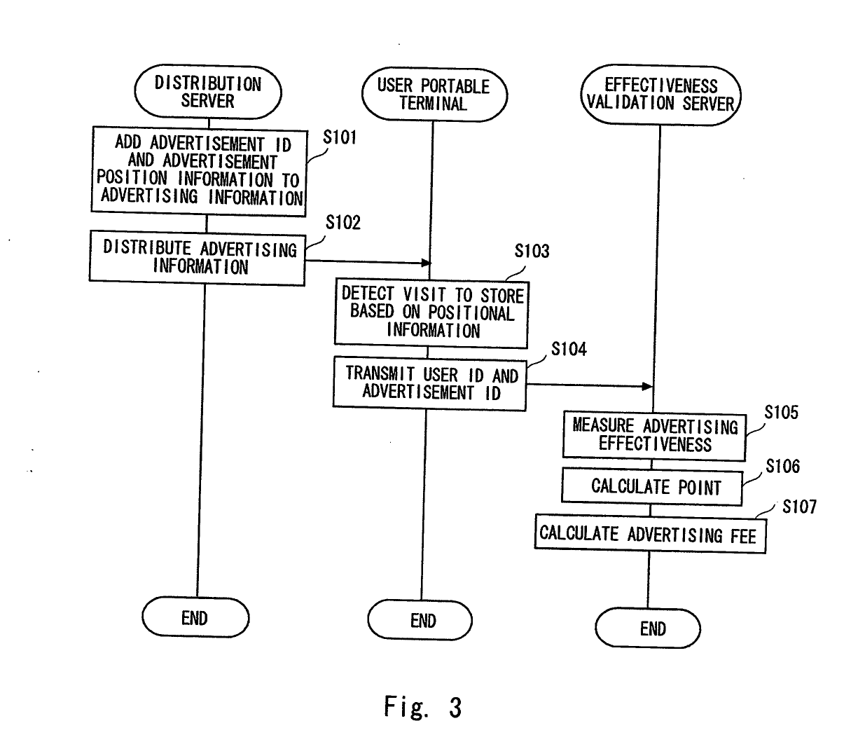

Next, the operation will be described. FIG. 3 is a flow chart showing one example of the processing in which the advertising distribution system distributes the advertising information and validates the advertising effectiveness. In the first embodiment, the advertisement distribution company makes a contract with each advertiser in advance, and each advertiser provides the advertising information that would be distributed to the user for the advertisement distribution company in advance. Note that an advertisement providing server managed by the advertiser may be provided, and this advertisement providing server may transmit the advertising information which is the distribution target to the distribution server 1 through communication network.

The distribution server 1 gives the advertisement ID which is capable of uniquely identifying the advertising information and gives the advertisement position information to the advertising information which is provided (step S101). In this case, for example, when the advertisement position information is provided from the advertiser in advance, the distribution server 1 adds the provided advertisement position information to the advertising information with the advertisement ID. Further, for example, the distribution server 1 obtains the advertisement position information by extracting the character string indicating the address of the store from the advertising information by performing text analysis processing or the like, and adds the advertisement position information to the advertising information.

Note that the distribution server 1 includes, for example, an advertising information database that stores the advertising information provided by each advertiser. The advertising information database is specifically implemented by a database apparatus such as a magnetic disk apparatus or an optical disk apparatus, and stores the advertising information to be made correspondent to the advertisement ID and the advertisement position information.

Then, the distribution server 1 transmits the advertising information to which the advertisement ID and the advertisement position information are added to the user portable terminal 3 through communication network (step S102). For example, the distribution server 1 transmits the advertising information to the user portable terminal 3 using an electronic mail. Upon reception of the advertising information, the user portable terminal 3 displays the advertisement content such as the store on a display unit such as a liquid crystal display unit or the like based on the received advertising information.

Note that the user portable terminal 3 may display the advertisement content such as the store according to the display operation by the user after receiving the advertising information, for example. Further, upon reception of an electronic mail including the URL indicating the location of the advertising information, the user portable terminal 3 may display the advertisement content such as the store as Web information by accessing the Web site indicated by the URL in accordance with the access operation by the user.

Further, the user portable terminal 3 stores the received advertising information to which the advertisement ID and the advertisement position information are added in the storing unit such as a memory.

The user checks the advertisement content displayed in the user portable terminal 3, and when having an interest in products or service 3 in the advertisement, visits the store with the user portable terminal 3.

The user portable terminal 3 detects the terminal position information with the sensor 32 at a predetermined timing. For example, the user portable terminal 3 detects the terminal position information with the sensor 32 for each predetermined time period. Further, for example, the user portable terminal 3 may detect the terminal position information at a timing of receiving the advertising information to which the advertisement ID and the advertisement position information are added or at a timing that the operation of indicating the position detection is carried out by the user.

The user portable terminal 3 judges whether or not the user has visited the store based on the advertisement position information added to the advertising information and the detected terminal position information (step S103). For example, upon judgment that the detected terminal position information matches the advertisement position information (or with a difference within a certain distance), the user portable terminal 3 judges that the user has visited the store. Upon judgment that the user has visited the store, the user portable terminal 3 extracts the advertisement ID added to the advertising information and the user ID stored in the storing unit such as a memory in advance, and transmits the IDs to the effectiveness validation server 2 through communication network (step S104).

Upon receiving the user ID and the advertisement ID, the effectiveness validation server 2 executes the processing of calculating the advertising effectiveness for the advertising information distribution based on the received user ID and the advertisement ID to generate the advertising effect information (step S105). Then, the effectiveness validation server 2 stores the generated advertising effect information in the advertisement effect database 26. Note that the effectiveness validation server 2 repeatedly executes the processing of step S1105 and occasionally updates the advertising effect information stored in the advertisement effect database 26 every time the effectiveness validation server 2 receives the user ID and the advertisement ID from each user portable terminal 3.

Further, the effectiveness validation server 2 calculates the point added to the user based on the advertising effect information stored in the advertisement effect database 26 at a predetermined timing (end of month, for example) (step S106). For example, the effectiveness validation server 2 calculates the point given to the user in accordance with the number of visits to the store by the user (the number of stores visited by the user) shown in the advertising effect information.

Note that the effectiveness validation server 2 includes a point information database that stores the point information indicating the calculated point, for example. The point information database is specifically implemented by a database apparatus such as a magnetic disk apparatus or an optical disk apparatus, and stores the point information to be made correspondent to the user ID.

Then, the advertisement distribution company gives the calculated point to the user. The effectiveness validation server 2 may transmit the point information to the user portable terminal 3 through communication network using an electronic mail or the like, for example. In this case, for example, the user may receive various services such as discount service or the like by presenting printed point information to a store personnel or by presenting the point information displayed in the display unit of the user portable terminal 3 to the store personnel when visiting the store next time.

Further, the effectiveness validation server 2 calculates the advertising fee charged to the advertiser based on the advertising effect information stored in the advertisement effect database 26 at a predetermined timing (end of month, for example) (step S107). For example, the effectiveness validation server 2 calculates the advertising fee charged to the advertiser according to the number of customers visiting the store shown in the advertising effect information.

Note that the effectiveness validation server 2 includes, for example, an advertising fee information database that stores the advertising fee information indicating the calculated advertising fee. The advertising fee information database is specifically implemented by a database apparatus such as a magnetic disk apparatus or an optical disk apparatus, and stores the advertising fee information to be made correspondent to the advertisement ID.

Then, the advertisement distribution company charges the advertiser for the calculated advertising fee, and the advertiser pays the advertising fee for the advertisement distribution company according to the charge. Note that the effectiveness validation server 2 may transmit the charge information to charge the calculated advertising fee to a terminal or the like of the advertiser through communication network using an electronic mail or the like. Further, for example, the effectiveness validation server 2 may pay the advertising fee by electronic payment by performing electronic payment processing based on the calculated advertising fee.

As described above, according to the first embodiment, the user portable terminal 3 automatically detects whether the user has visited the store based on the advertisement position information added to the advertising information. Further, upon detection of the user visit, the user portable terminal 3 transmits the user ID and the advertisement ID to the effectiveness validation server 2. Then, the effectiveness validation server 2 executes the processing to calculate the advertising effectiveness for the advertising information distribution based on the user ID and the advertisement ID received from the user portable terminal 3. Thus, there is no need to perform special operation by a store personnel and to arrange a store terminal such as a point card reader or the like in the store to detect the user visit. Accordingly, the advertising information can be distributed and the advertising effectiveness can be validated without increasing the burden on the store side.

### Second Embodiment

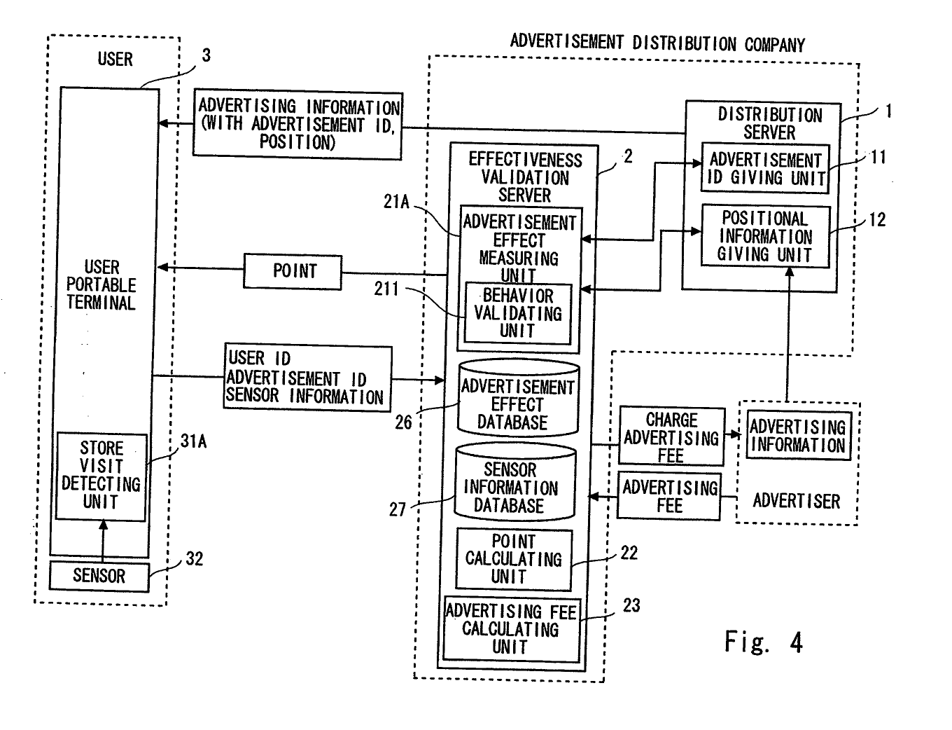

Next, the second embodiment of the present invention will be described with reference to the drawings. FIG. 4 is a block diagram showing a configuration example of a store-visit-guaranteed advertising distribution system according to the second embodiment. As shown in FIG. 4, the second embodiment is different from the first embodiment in that the advertisement effect measuring unit 21A includes a behavior validating unit 211 and the effectiveness validation server 2 includes a sensor information database 27 in addition to the components shown in FIG. 1B. Further, in the second embodiment, the function of a store visit detecting unit 31A is different from the function of the store visit detecting unit 31 shown in the first embodiment.

Note that the functions of the components other than the advertisement effect measuring unit 21A including the behavior validating unit 211, the sensor information database 27, and the store visit detecting unit 31A are similar to those shown in the first embodiment.

The sensor information database 27 is specifically realized by a database apparatus such as a magnetic disk apparatus or an optical disk apparatus. In the second embodiment, when a sensor 32 that is impaired or improperly converted (or suspected of being improperly converted) is known among each sensor 32 included in each user portable terminal 3, the sensor information database 27 stores the sensor information indicating the sensor 32 that is impaired or improperly converted. Note that the sensor information stored in the sensor information database 27 is registered by the advertisement distribution company according to the report or the like by the user, for example.

The advertisement effect measuring unit 21A includes a function of receiving the sensor information that is capable of identifying the sensor 32 of the user portable terminal 3 from the user portable terminal 3 through communication network with the user ID and the advertisement ID in addition to the function of the advertisement effect measuring unit 21 shown in the first exemplary embodiment. Further, the advertisement effect measuring unit 21A includes a function of preventing the processing of the advertisement effect measuring upon judgment by the behavior validating unit 211 that the reliability of detection of the position of the user portable terminal 3 is low.

The behavior validating unit 211 is specifically realized by a CPU of an information processing apparatus which is operated according to a program. The behavior validating unit 211 includes a function of estimating the reliability of the position detection using the sensor 32 of the user portable terminal 3 and executing the processing of validating whether the user is entitled to get the point or the advertising fee should be charged based on the sensor information received from the user portable terminal 3.

More specifically, the behavior validating unit 211 judges whether there is sensor information that matches the sensor information received from the user portable terminal 3 among the sensor information stored in the sensor information database 27. When there is no sensor information that matches, the behavior validating unit 211 judges that the reliability of the position detection of the user portable terminal 3 is high and performs control to execute the processing of the advertisement effect measuring. When there is a sensor that matches, the behavior validating unit 211 judges that the reliability of the position detection of the user portable terminal 3 is low, and performs control not to execute the processing of the advertisement effect measuring.

The store visit detecting unit 31A includes a function of transmitting the sensor information with the user ID and the advertisement ID to the effectiveness validation server 2 through communication network in addition to the function shown in the first embodiment.

For example, the store visit detecting unit 31A stores, as the sensor information, the sensor ID that is capable of identifying the sensor 32 included in the user portable terminal 3 (a manufacturing number of a transceiver or a GPS receiver, for example) in the storing unit such as a memory in advance. Further, for example, the store visit detecting unit 31A may store, as the sensor information, the information indicating the attributes of the sensor 32 (information indicating the name of the sensor, the position detection accuracy, and resolution, for example) in the storing unit such as a memory in advance. Upon judgment that the user has visited the store, the store visit detecting unit 31A extracts the sensor information from the storing unit with the user ID and the advertisement ID and transmits the extracted information to the effectiveness validation server 2.

Note that the storage device of the effectiveness validation server 2 in the second embodiment stores various programs for validating the advertising effectiveness for the advertising information distribution as in the first embodiment. For example, the storage device of the effectiveness validation server 2 stores an advertising effectiveness validation program for causing a computer to implement a position calculating means identifying information reception processing that receives the store visit information including position calculating means identifying information that is capable of identifying the terminal position calculating means used by a user terminal for calculating the position from the user terminal through communication network, a reliability judgment processing that judges the reliability of the positional calculation using the terminal position calculating means by the user terminal based on the position calculating means identifying information that is received, and an advertising effectiveness validation processing that validates the advertising effectiveness based on the judgment that the reliability of the positional calculation with the terminal position calculating means is high.

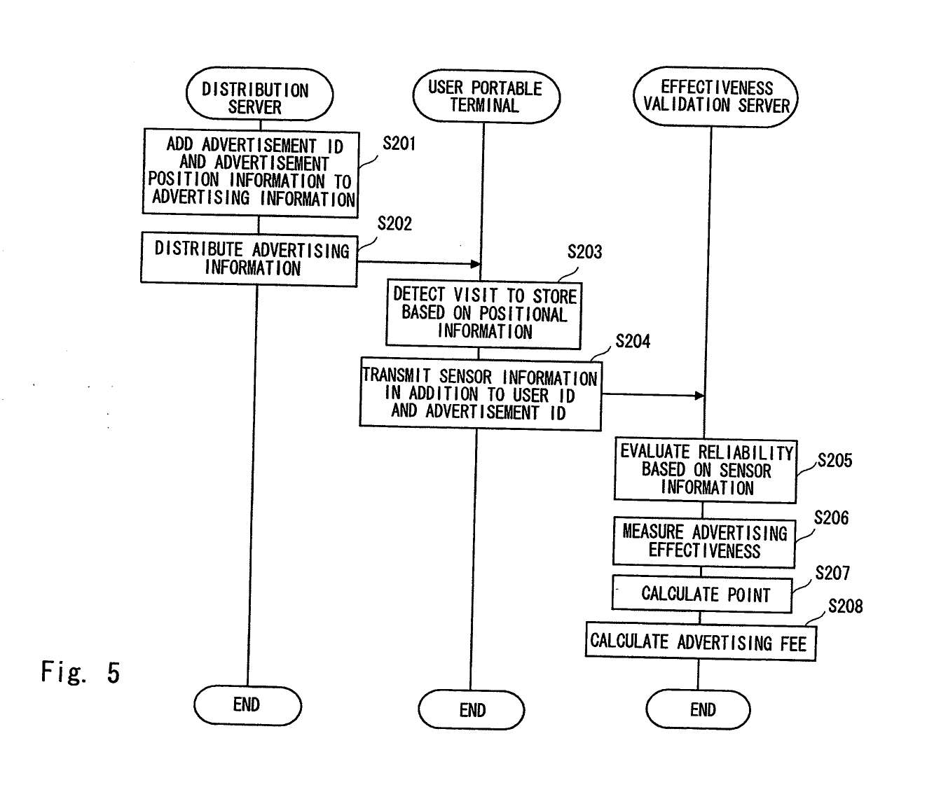

Next, the operation will be described. FIG. 5 is a flow chart showing a processing example in which the advertising distribution system according to the second embodiment distributes the advertising information and validates the advertising effectiveness. In FIG. 5, the processing of steps S201 to S203 is similar to the processing of steps S101 to S103 shown in the first embodiment.

Upon judgment that the user has visited the store, the user portable terminal 3 extracts the sensor information, the advertisement ID added to the advertising information, and the user ID stored in the storing unit such as a memory in advance, and transmits the extracted information to the effectiveness validation server 2 through communication network (step S204).

Upon reception of the user ID, the advertisement ID, and the sensor information, the effectiveness validation server 2 judges whether the reliability of the position detection using the sensor 32 of the user portable terminal 3 is high on the basis of the received sensor information (step S205).

In step S205, the effectiveness validation server 2 judges whether there is sensor information that matches the received sensor information among the sensor information stored in the sensor information database 21B. When it is judged that there is sensor information that matches, the effectiveness validation server 2 judges that the reliability of the position detection using the sensor 32 of the user portable terminal 3 is low, and prevents the step from moving to the processing of step S206 to prevent the processing of the advertisement effect measuring from being executed. Further, when it is judged that there is no sensor information that matches, the effectiveness validation server 2 judges that the reliability of the position detection using the sensor 32 of the user portable terminal 3 is high, and the step moves to the processing of the advertisement effect measuring in step S206.

From the execution of the above processing, it is possible to perform control not to execute the processing of counting the number of visits to the store by the user and the number of customers visiting the store when the information indicating that the sensor 32 is impaired or improperly converted is registered in the sensor information database 21B in advance.

Note that the processing of steps S206 to S108 is similar to the processing of steps S105 to S107 shown in the first embodiment.

As described above, according to the second embodiment, the behavior validating unit 211 of the effectiveness validation server 2 estimates the reliability of the position information detected by the user portable terminal 3 with the sensor 32 based on the sensor information. Then, upon judgment of the low reliability, the effectiveness validation server 2 prevents the processing of the advertisement effect measuring, which prevents point addition and calculation of the advertising fee. Accordingly, it is possible to prevent misbehavior such as acquiring points by improperly using the positional sensor.

### Third Embodiment

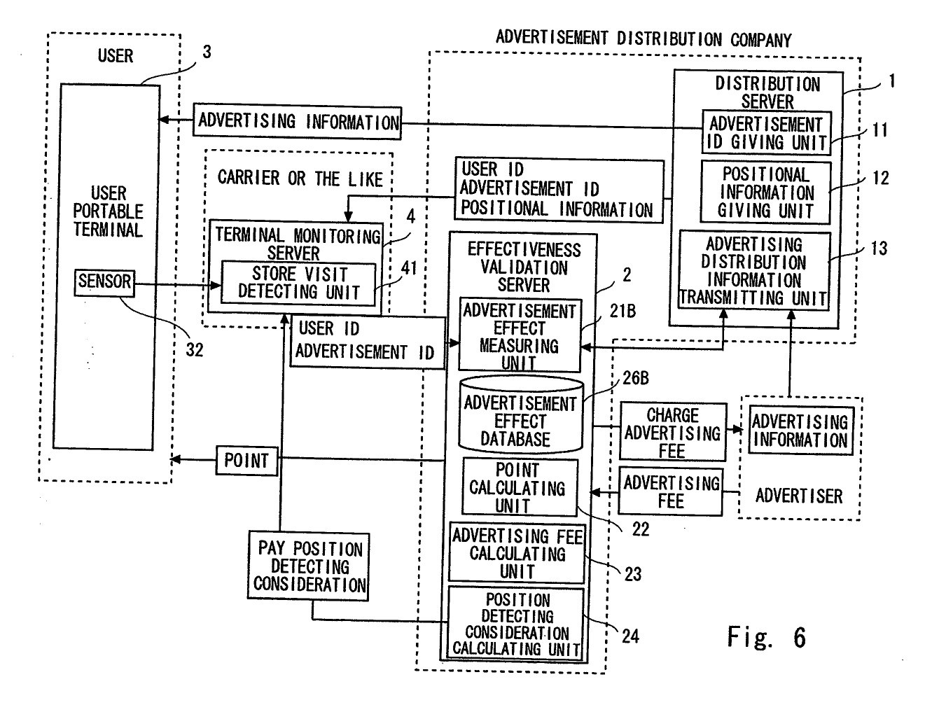

Next, the third embodiment of the present invention will be described with reference to the drawings. FIG. 6 is a block diagram showing a configuration example of a store-visit-guaranteed advertising distribution system according to the third embodiment. As shown in FIG. 6, the third embodiment is different from the first embodiment in that the advertising distribution system includes a terminal monitoring server 4 in addition to the components shown in FIG. 1B. Further, the third embodiment is different from the first embodiment in that the distribution server 1 includes an advertising distribution information transmitting unit 13 in addition to the components shown in FIG. 1B. Further, the third embodiment is different from the first embodiment in that the effectiveness validation server 2 includes a position detecting consideration calculating unit 24 in addition to the components shown in FIG. 1B.

Further, in the third embodiment, the function of an advertisement effect measuring unit 21B is different from the function of the advertisement effect measuring unit 21 shown in the first embodiment. Further, the information stored in an advertisement effect database 26B is different from the information stored in the advertisement effect database 26 shown in the first embodiment.

Note that the functions of the components other than the terminal monitoring server 4, the advertising distribution information transmitting unit 13, the advertisement effect measuring unit 21B, the position detecting consideration calculating unit 24, and the advertisement effect database 26B are similar to those shown in the first embodiment.

The terminal monitoring server 4 is a server managed by a communication carrier, and in particular, realized by an information processing apparatus such as a personal computer operated according to a program. As shown in FIG. 6, the terminal monitoring server 4 includes a store visit detecting unit 41.

More specifically, the store visit detecting unit 41 is realized by a network interface unit and a CPU of an information processing apparatus operated according to a program. The store visit detecting unit 41 includes a function of judging whether the user has visited the store based on the terminal position information of the user portable terminal 3.

For example, the store visit detecting unit 41 receives the advertisement position information, the advertisement ID added to the advertising information, and the user ID of the user to which the advertising information is distributed from the distribution server 1 through communication network, and stores the received information in a storage device such as a hard disk drive or the like. Further, the store visit detecting unit 41 obtains the terminal position information and judges whether the obtained position information matches the advertisement position information stored in the storage device (or with a difference within a certain distance). If the obtained position information matches the advertisement position information (or with a difference within a certain distance), the store visit detecting unit 41 judges that the user has visited the store.

For example, when the user portable terminal 3 includes a GPS function, the store visit detecting unit 41 may receive the terminal position information obtained by the user portable terminal 3 (latitude and longitude) from the user portable terminal 3 with the user ID for every predetermined time period. The store visit detecting unit 41 may judge whether the user has visited the store by judging whether the received terminal position information matches the advertisement position information stored in advance (or with a difference within a certain distance).

Further, for example, the store visit detecting unit 41 may detect a plurality of wireless base stations (wireless area) to which the user portable terminal 3 can be connected using the position registration function of each wireless base station for each predetermined time period. In this case, for example, the store visit detecting unit 41 stores a correspondence table in which the position information (address or latitude/longitude) and the wireless area information are made correspondent to each other in a storage device such as a hard disk drive in advance. Then, the store visit detecting unit 41 extracts the position information in accordance with the detected wireless area information from the correspondence table, so as to estimate the position of the user portable terminal 3 and obtain the terminal position information.

Further, for example, when the communication carrier that manages the terminal monitoring server 4 provides a hot spot service, the store visit detecting unit 41 may estimate the position of the user portable terminal 3 to obtain the terminal position information by detecting to which access point of the wireless LAN the user portable terminal 3 is connected.

Further, the store visit detecting unit 41 includes a function of transmitting the user ID and the advertisement ID to the effectiveness validation server 2 through communication network upon judgment that the user has visited the store.

The advertisement effect measuring unit 21B includes a function of calculating the data indicating the number of times that the terminal monitoring server 4 performs the position detection of the user portable terminal 3 (or the number of times of detection that the user has visited the store) as the advertising effect information by counting the number of times of reception of the user ID and the advertisement ID in addition to the function of the advertisement effect measuring unit 21 shown in the first embodiment.

The advertisement effect database 26B stores the times of position detection calculated by the advertisement effect measuring unit 21B as the advertising effect information in addition to the number of customers visiting the store or the number of visits to the store by the user (the number of stores visited by the user) shown in the first embodiment.

More specifically, the position detecting consideration calculating unit 24 is realized by a CPU of an information processing apparatus operated according to a program. The position detecting consideration calculating unit 24 includes a function of calculating the consideration for the position detection processing paid to the communication carrier (hereinafter referred to as position detecting consideration) based on the advertising effect information stored in the advertisement effect database 26B. For example, the position detecting consideration calculating unit 24 calculates the position detecting consideration paid to the communication carrier in accordance with the times of position detection shown in the advertising effect information.

Note that the effectiveness validation server 2 may include the behavior validating unit 211 and the sensor information database 27, as is similar to the second embodiment. Then, the effectiveness validation server 2 may receive the sensor information from the user portable terminal 3 through the terminal monitoring server 4, and judges whether the reliability of the position detection of the user portable terminal 3 is high based on the sensor information stored in the sensor information database 27 and the received sensor information. When the reliability is low, the effectiveness validation server 2 may perform control not to execute the processing of the advertisement effect measuring.

Specifically, the advertising distribution information transmitting unit 13 is realized by a network interface unit and a CPU of an information processing apparatus that is operated according to a program. The advertising distribution information transmitting unit 13 includes a function of transmitting the user ID of the user to which the advertising information is distributed, the advertisement position information, and the advertisement ID added to the advertising information to the terminal monitoring server 4 through communication network.

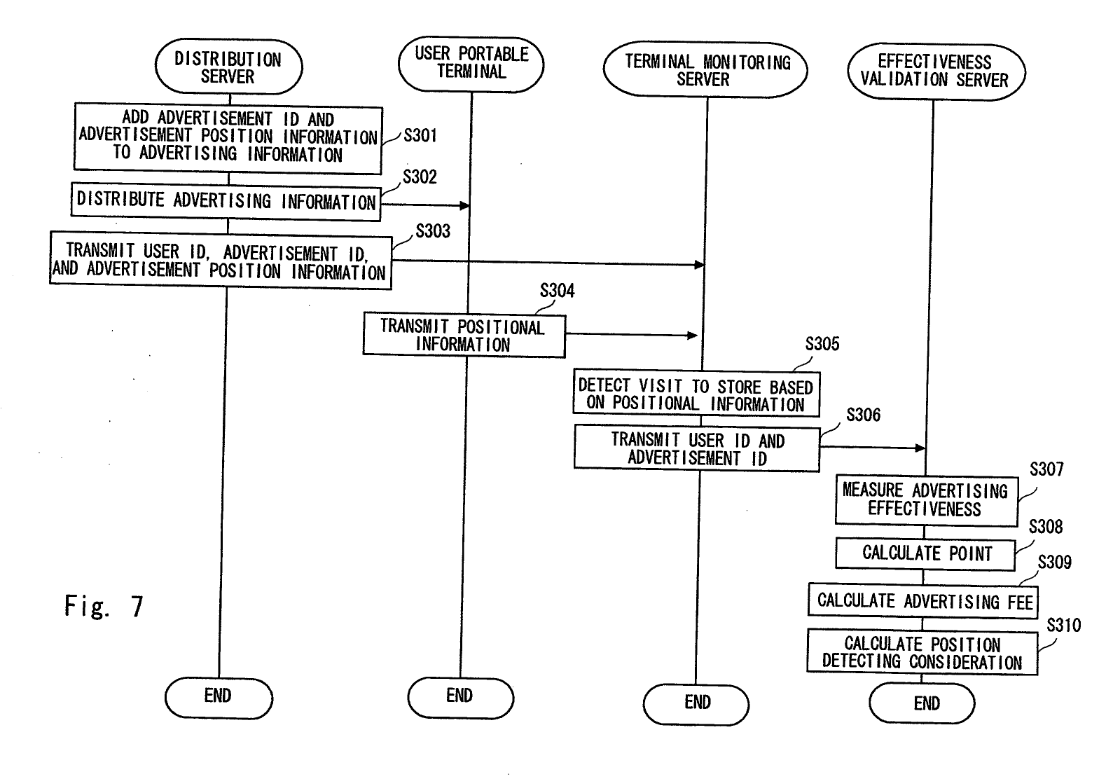

Next, the operation will be described. FIG. 7 is a flow chart showing a processing example in which the advertising distribution system according to the third embodiment distributes the advertising information and validates the advertising effectiveness. Note that, in the third embodiment, the advertisement distribution company makes a contract with each advertiser in advance, and at the same time, makes a contract with the communication carrier in advance for performing the position detection processing of the user portable terminal 3. In FIG. 7, the processing of steps S301 and S302 is similar to the processing of steps S101 and S102 shown in the first embodiment.

Upon distributing the advertising information, the distribution server 1 transmits the user ID of the user of the user portable terminal 3 to which the advertising information is distributed, the advertisement position information, and the advertisement ID added to the distributed advertising information to the terminal monitoring server 4 through communication network (step S303). Further, the terminal monitoring server 4 stores the advertisement position information, the advertisement ID, and the user ID that are received to a storage device such as a hard disk drive.

Then, when including a GPS function, for example, the user portable terminal 3 calculates the terminal position information for each predetermined time period and transmits the calculated information to the terminal monitoring server 4 through communication network (step S304). Then, the terminal monitoring server 4 judges whether the user has visited the store based on the terminal position information received from the user portable terminal 3 (step S305). Note that, instead of receiving the terminal position information from the user portable terminal 3, the terminal monitoring server 4 may obtain the terminal position information based on the information from each wireless base station to judge whether the user has visited the store based on the obtained terminal position information.

Upon judgment that the user has visited the store, the terminal monitoring server 4 extracts the user ID and the advertisement ID stored in the storage device such as a hard disk drive and transmits the extracted IDs to the effectiveness validation server 2 through communication network (step S306).

Upon receiving the user ID and the advertisement ID, the effectiveness validation server 2 generates the advertising effect information based on the user ID and the advertisement ID that are received (step S307). In this case, the effectiveness validation server 2 generates the times of position detection as the advertising effect information in addition to the number of customers visiting the store or the number of visits to the store by the user (the number of stores visited by the user) shown in the first embodiment. Then, the effectiveness validation server 2 stores the generated advertising-effect information in the advertisement effect database 26B.

The processing of steps S308 and S309 is similar to those of steps S106 and S107 shown in the first embodiment.

Next, the effectiveness validation server 2 calculates the position detecting consideration paid to the communication carrier based on the advertising effect information stored in the advertisement effect database 26B (step S310). For example, the effectiveness validation server 2 calculates the position detecting consideration paid to the communication carrier according to the times of position detection shown in the advertising effect information.

Note that the effectiveness validation server 2 includes a position detecting consideration information database (specifically realized by a database apparatus such as a magnetic disk apparatus or an optical disk apparatus), for example, and stores the position detecting consideration information indicating the calculated position detecting consideration in the position detecting consideration information database.

Then, the advertisement distribution company pays the calculated position detecting consideration to the communication carrier. Note that, for example, when the terminal monitoring server 4 includes an electronic payment function, the effectiveness validation server 2 may pay the position detecting consideration by electronic payment by transmitting the payment information including the calculated position detecting consideration to the terminal monitoring server 4 through communication network.

As stated above, according to the third embodiment, the terminal monitoring server 4 managed by the communication carrier that manages the position information of the user portable terminal 3 judges whether the user has visited the store, and provides the information regarding the store visit to the effectiveness validation server 2 managed by the advertisement distribution company. Thus, a new business model can be realized in which the advertisement distribution company pays the consideration for providing the information by position detection for the communication carrier.

### Fourth Embodiment

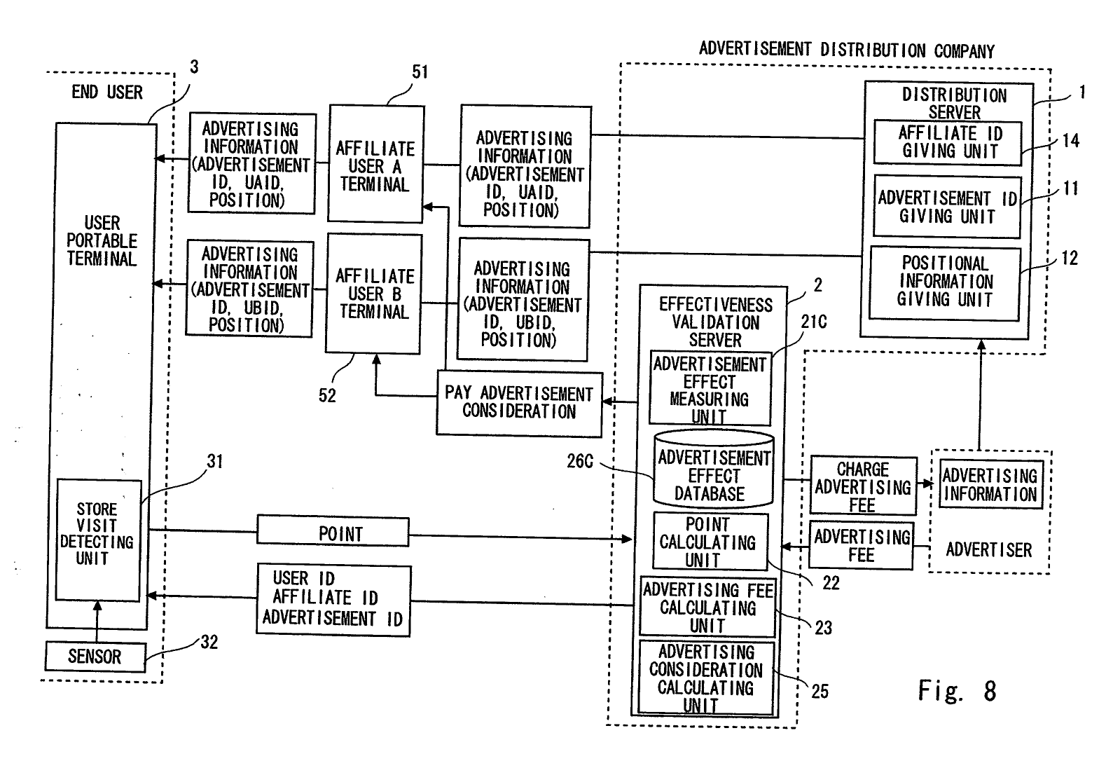

Next, the fourth embodiment of the present invention will be described with reference to the drawings. FIG. 8 is a block diagram showing a configuration example of a store-visit-guaranteed advertising distribution system according to the fourth embodiment. In the fourth embodiment, instead of directly distributing the advertising information to the user portable terminal 3 of the user (end user), the distribution server 1 of the advertisement distribution company distributes the advertising information to a terminal of an affiliate user who mediates the advertising information. Then, the advertising information is transferred from the terminal of the affiliate user to the user portable terminal 3.

As shown in FIG. 8, the fourth embodiment is different from the first embodiment in that the advertising distribution system includes affiliate user terminals 51 and 52 in addition to the components shown in FIG. 1B. The fourth embodiment is further different from the first embodiment in that the distribution server 1 includes an affiliate ID giving unit 14 in addition to the components shown in FIG. 1B. Furthermore, the fourth embodiment is different from the first embodiment in that the effectiveness validation server 2 includes an advertising consideration calculating unit 25 in addition to the components shown in FIG. 1B.

Further, in the fourth embodiment, the function of an advertisement effect measuring unit 21C is different from the function of the advertisement effect measuring unit 21 shown in the first embodiment. Further, the information stored in an advertisement effect database 26C is different from the information stored in the advertisement effect database 26 shown in the first embodiment.

Note that the functions of the components other than the affiliate user terminals 51 and 52, the affiliate ID giving unit 14, the advertisement effect measuring unit 21C, the advertising consideration calculating unit 25, and the advertisement effect database 26C are similar to those shown in the first embodiment.

Specifically, the affiliate ID giving unit 14 is realized by a network interface unit and a CPU of an information processing apparatus operated according to a program. The affiliate ID giving unit 14 includes a function of giving an affiliate ID for identifying the affiliate user to the affiliate user. Further, the affiliate ID giving unit 14 includes a function of further giving an affiliate ID to the advertising information to which the advertisement ID and the advertisement position information are added. Further, the affiliate ID giving unit 14 includes a function of transmitting the advertising information to which the affiliate ID, the advertisement ID, and the advertisement position information are added to the affiliate user terminals 51 and 52 through communication network.

The affiliate user terminals 51 and 52 are terminals used by the affiliate user, and more specifically, portable terminals such as portable telephones or the like that are operated according to a program. Further, the affiliate user terminals 51 and 52 may be terminals such as PDAs, for example, as long as the terminals can be carried by the affiliate user. Although two affiliate user terminals 51 and 52 are shown in FIG. 8, the advertising distribution system may include three or more affiliate user terminals, for example, instead of two.

The affiliate user terminals 51 and 52 include a function of receiving the advertising information to which the affiliate ID, the advertisement ID, and the advertisement position information are added from the distribution server 1 through communication network. Further, the affiliate user terminals 51 and 52 include a function of transferring the received advertising information to which the affiliate ID, the advertisement ID, and the advertisement position information are added to the user portable terminal 3 through communication network.

The advertisement effect measuring unit 21C includes a function of receiving the affiliate ID, the user ID, and the advertisement ID from the user portable terminal 3 through communication network in addition to the function of the advertisement effect measuring unit 21 shown in the first embodiment. Further, the advertisement effect measuring unit 21C includes a function of calculating the number of times that the user (end user) has actually visited the store (hereinafter also called actual number of visits to the store) as the advertising effect information for each affiliate user by counting the number of times of reception of the affiliate ID.

Further, for example, the advertisement effect measuring unit 21C may acquire (receive) the number of times of distribution of the advertising information to the affiliate user terminals 51 and 52 (hereinafter also called number of times of advertisement distribution) from the distribution server 1. Then, the advertisement effect measuring unit 21C may calculate the rate (hereinafter also called hit rate) that the user (end user) has actually visited the store with respect to the number of times that the advertising information is distributed to the affiliate user as the advertising effect information by dividing the actual number of visits to the store by the number of times of advertisement distribution, for example.

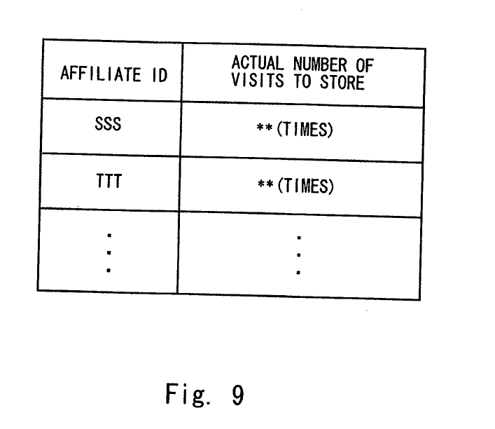

The advertisement effect database 26C stores the actual number of visits to the store and the hit rate calculated by the advertisement effect measuring unit 21B as the advertising effect information in addition to the number of customers visiting the store or the number of visits to the store by the user (the number of stores visited by the user) shown in the first embodiment. For example, the advertisement effect database 26C stores the actual number of visits to the store (or hit rate) to be made correspondent to the affiliate ID as shown in FIG. 9.

Specifically, the advertising consideration calculating unit 25 is realized by a CPU of an information processing apparatus operated according to a program. The advertising consideration calculating unit 25 includes a function of calculating the consideration for the advertising information transfer paid for the affiliate user (hereinafter called advertisement transferring consideration) based on the advertising effect information stored in the advertisement effect database 26C. For example, the advertising consideration calculating unit 25 calculates the advertisement transferring consideration paid for the affiliate user in accordance with the actual number of visits to the store and the hit rate shown in the advertising effect information. The advertising consideration calculating unit 25 may calculate the point given to the affiliate user.

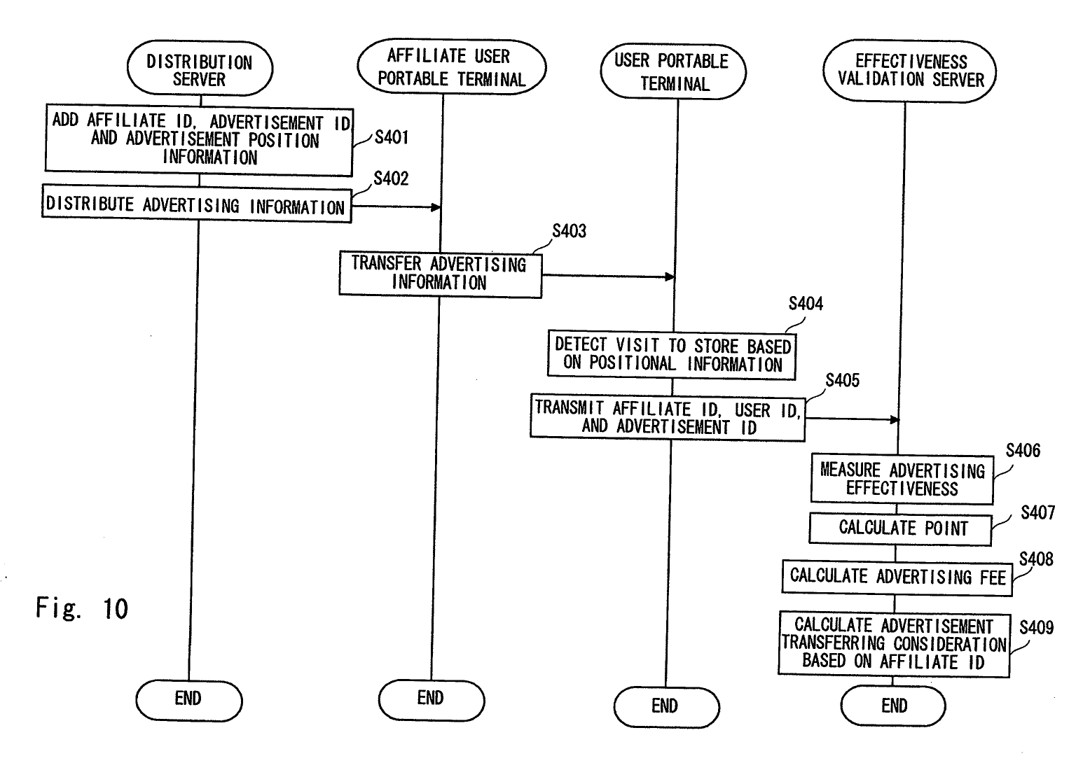

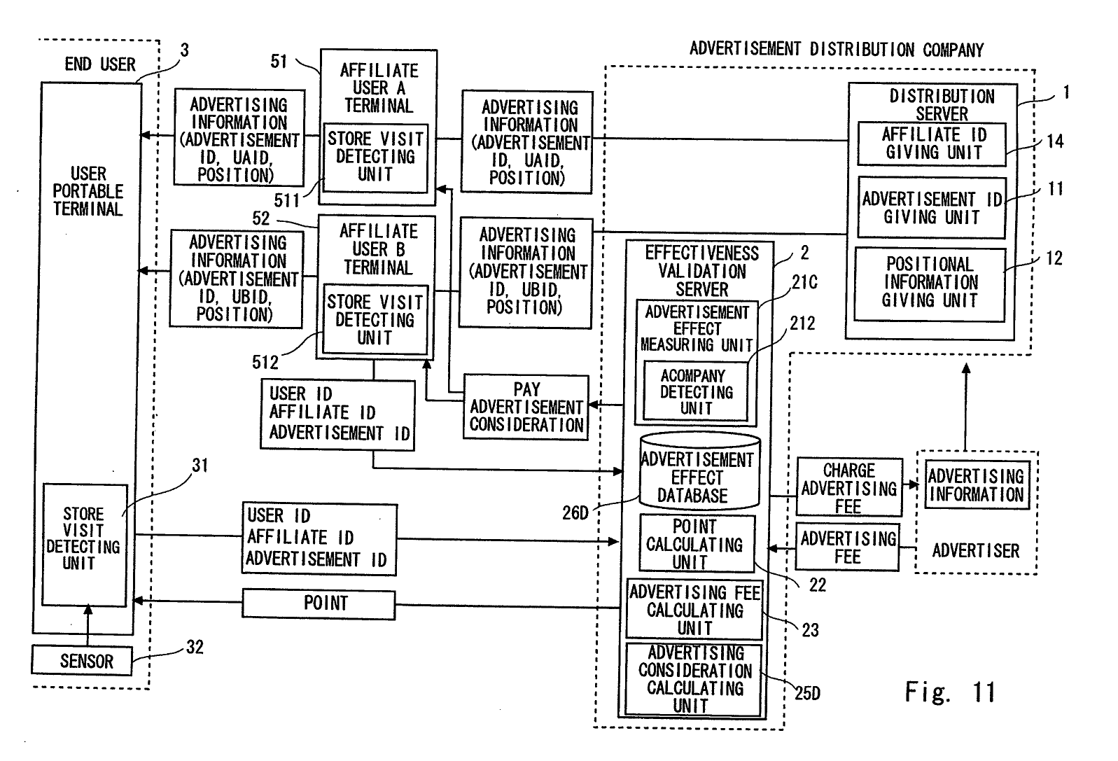

The operation will be described next. FIG. 10 is a flow chart showing a processing example in which the advertising distribution system according to the fourth embodiment distributes the advertising information and validates the advertising effectiveness. The distribution server 1 gives the advertisement ID and the advertisement position information and gives the affiliate ID to the provided advertising information (step S401). Note that, in this case, the distribution server 1 stores the advertising information in the advertising information database to be made correspondent to the affiliate ID in addition to the advertisement ID and the advertisement position information.

Next, the distribution server 1 transmits the advertising information to which the advertisement ID, the advertisement position information, and the affiliate ID are added to the affiliate user terminals 51 and 52 through communication network (step S402). Upon receiving the advertising information, the affiliate user terminals 51, 52 each displays the advertisement content such as a store on a display unit such as a liquid crystal display unit based on the received advertising information. Further, the affiliate user terminals 51 and 52 each stores the received advertising information to which the advertisement ID, the advertisement position information, and the affiliate ID are added in a storing unit such as a memory.

Note that each affiliate user makes a contract (hereinafter also called affiliate contract) with the advertisement distribution company for transferring the advertising information in advance, and the distribution server 1 may distribute the advertising information to the terminal which is registered as the affiliate user in advance. Further, instead of executing the affiliate contract in advance, the distribution server 1 may randomly give the affiliate ID to the user who has registered in the advertising distribution service to transmit the advertising information to the user, for example.

The affiliate user checks the advertisement content displayed in the affiliate user terminals 51 and 52 and executes transfer operation of the advertising information to an acquaintance of the affiliate user, or the end user, that would likely to have an interest in products or services in the advertisement. The affiliate user terminals 51 and 52 transfer the advertising information to which the advertisement ID, the advertisement position information, and the affiliate ID are added to the user portable terminal 3 through communication network in accordance with the operation of the affiliate user (step S403).

Note that, in step S403, the affiliate user terminals 51 and 52 may transfer the advertising information to the user portable terminal 3 with an electronic mail, for example. Alternatively, the affiliate user terminals 51 and 52 may transfer the advertising information by infrared communication with IrDA, for example, or may transfer the advertising information by wireless communication using Bluetooth, Felica (registered trademark), or NFC (Near Field Communication).

The user portable terminal 3 detects the terminal position information using the sensor 32 at a predetermined timing in accordance with the processing similar to step S103 which is shown in the first embodiment, and judges whether the user has visited the store based on the advertisement position information added to the advertising information and the detected terminal position information (step S404). Upon judgment of the user visit, the user portable terminal 3 extracts the user ID stored in the storing unit such as a memory in advance, and the advertisement ID and the affiliate ID added to the advertising information, and transmits the extracted IDs to the effectiveness validation server 2 through communication network (step S405).

Upon receiving the user ID, the advertisement ID, and the affiliate ID, the effectiveness validation server 2 executes the processing to measure the advertising effectiveness to the advertising information distribution based on the user ID, the advertisement ID, and the affiliate ID that are received, and generates the advertising effect information (step S406). In this case, the effectiveness validation server 2 generates the actual number of visits to the store and the hit rate as advertising effect information in addition to the number of customers visiting the store or the number of visits to the store by the user (the number of stores visited by the user) shown in the first embodiment. Then, the effectiveness validation server 2 stores the generated advertising effect information in the advertisement effect database 26C.

The processing of steps S407 and S408 is similar to the processing of steps S106 and S107 shown in the first embodiment.

Next, the effectiveness validation server 2 calculates the advertisement transferring consideration paid for the affiliate user for each affiliate user based on the advertising effect information stored in the advertisement effect database 26C (step S409). For example, the effectiveness validation server 2 calculates the advertisement transferring consideration paid for the affiliate user according to the actual number of visits to the store and the hit rate shown in the advertising effect information. Note that the effectiveness validation server 2 may calculate the advertisement transferring consideration for each genre of the advertisement.

Note that the effectiveness validation server 2 includes, for example, an advertisement transferring consideration information database (which is implemented by a database apparatus such as a magnetic disk apparatus or an optical disk apparatus), where the advertisement transferring consideration information indicating the calculated advertisement transferring consideration is stored.

Then, the advertisement distribution company pays the calculated advertisement transferring consideration to the affiliate user. Note that the effectiveness validation server 2 may pay the advertisement transferring consideration with the electronic money or the like based on the calculated advertisement transferring consideration, for example.

As described above, according to the fourth embodiment, it is possible to realize a new business model in which the consideration is paid for the affiliate user that transfers the advertising information in accordance with the actual visit to the store by the end user. Further, there is no need to perform special operation by a store personnel and to install a store terminal such as a point card reader or the like in the store to realize the affiliate business. Accordingly, the affiliate business can be realized without increasing the burden on the store side.

### Fifth Embodiment

Next, the fifth embodiment of the present invention will be described with reference to the drawings. FIG. 11 is a block diagram showing a configuration example of a store-visit-guaranteed advertising distribution system according to the fifth embodiment. In the fifth embodiment, as is similar to the fourth embodiment, instead of directly distributing the advertisement to the user portable terminal 3 of the end user from the distribution server 1, the advertisement is firstly distributed to the terminal of the affiliate user, and then the advertising information is transferred to the user portable terminal 3 of the end user.

As shown in FIG. 11, the fifth embodiment is different from the fourth embodiment in that the affiliate user terminals 51 and 52 include store visit detecting units 511 and 512, respectively, in addition to the components shown in FIG. 8. Further, the fifth embodiment is different from the fourth embodiment in that the advertisement effect measuring unit 21 includes a company detecting unit 212 in addition to the components shown in FIG. 8.

Further, in the fifth embodiment, the function of an advertising consideration calculating unit 25D is different from that of the advertising consideration calculating unit 25 shown in the fourth embodiment. Further, the information stored in an advertisement effect database 26D is different from the information stored in the advertisement effect database 26C shown in the fourth embodiment.

Specifically, the store visit detecting units 511 and 512 are implemented by a transceiver and a CPU of a portable terminal operated in accordance with a program. The store visit detecting units 511 and 512 include a function of detecting the position information (latitude and longitude, for example) of the affiliate user terminals 51, 52. Hereinafter, the position information of the affiliate user terminals 51 and 52 detected by the store visit detecting units 511 and 512 is also referred to as affiliate terminal position information.

For example, the store visit detecting units 511 and 512 include a sensor (GPS receiver or transceiver, for example) as is similar to the user portable terminal 3, and obtain affiliate terminal information in accordance with the processing similar to that of the sensor 32 of the user portable terminal 3.

Further, the store visit detecting units 511, 512 include a function of judging whether the affiliate user has visited the store in accordance with the processing similar to that of the store visit detecting unit 31 of the user portable terminal 3 based on the affiliate terminal position information. Further, the store visit detecting units 511, 512 include a function of transmitting the user ID, the advertisement ID, and the affiliate ID to the effectiveness validation server 2 through communication network upon judgment that the affiliate user has visited the store.

Specifically, the company detecting unit 212 is implemented by a network interface unit and a CPU of an information processing apparatus operated according to a program. The company detecting unit 212 includes a function of judging whether the end user and the affiliate user have visited the store together based on the user ID, the advertisement ID, and the affiliate ID received from the affiliate user terminals 51, 52, and the user ID, the advertisement ID, and the affiliate ID received from the user portable terminal 3.

More specifically, the company detecting unit 212 judges whether the timing of receiving the user ID, the advertisement ID, and the affiliate ID from the affiliate user terminals 51, 52 and the timing of receiving the same user ID, the advertisement ID, and the affiliate ID from the user portable terminal 3 are the same (or within a predetermined time period). Upon judgment that they are the same (or within a predetermined time period), the company detecting unit 212 judges that the end user and the affiliate user have visited the store together.

Further, the company detecting unit 212 includes a function of counting the number of times that the end user and the affiliate user have visited the store together (hereinafter also called number of accompanying visits to the store) and calculating the number as the advertising effect information.

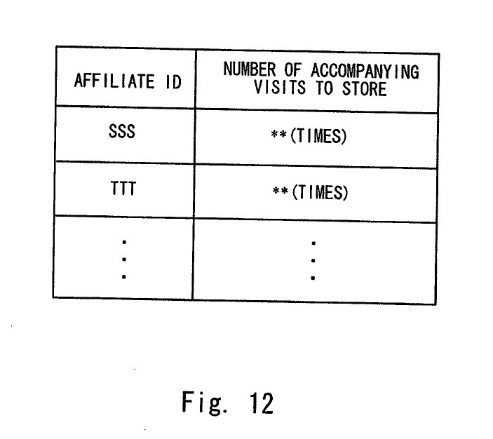

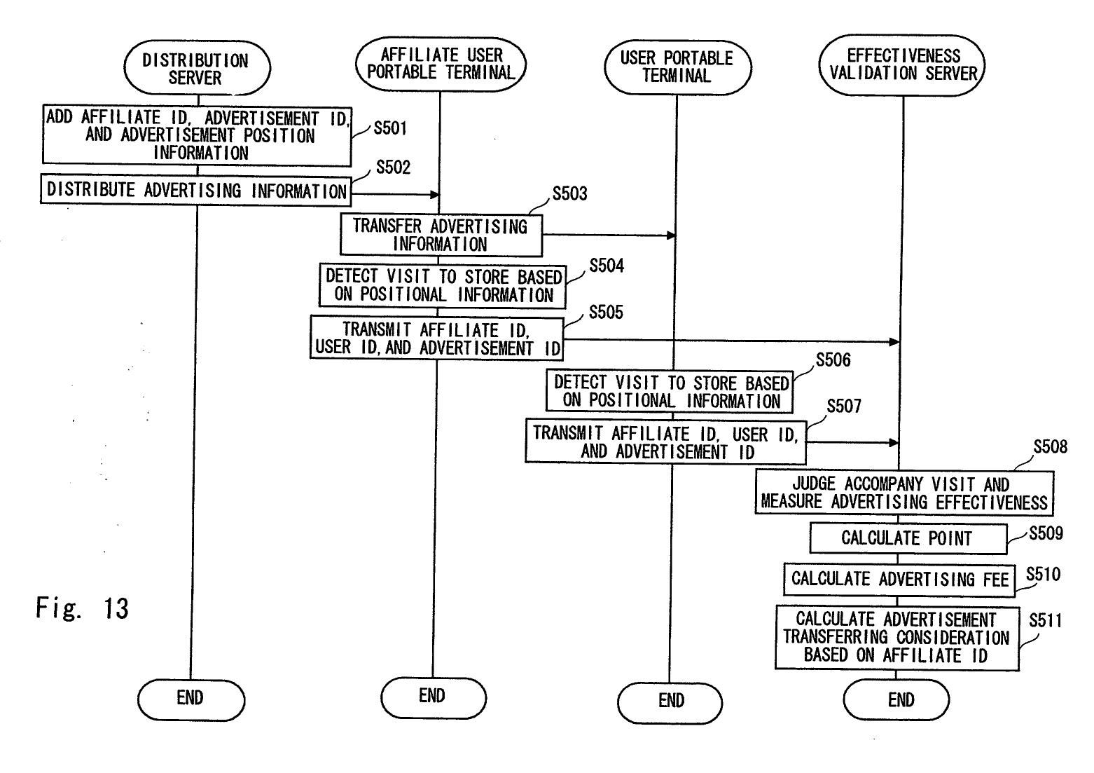

The advertisement effect database 26D stores the number of accompanying visits to the store calculated by the company detecting unit 212 as the advertising effect information in addition to the number of customers visiting the store, the number of visits to the store by the user (the number of stores visited by the user), and the actual number of visits to the store (or hit rate) shown in the fourth embodiment. For example, the advertisement effect database 26D stores, as shown in FIG. 12, the number of accompanying visits to the store so as to be made correspondent to the affiliate ID.

The advertising consideration calculating unit 25D includes a function of calculating the advertisement transferring consideration paid for the affiliate user based on the advertising effect information stored in the advertisement effect database 26D. In the fifth embodiment, the advertising consideration calculating unit 25D calculates the advertisement transferring consideration paid for the affiliate user in accordance with the number of accompanying visits to the store in addition to the actual number of visits to the store and the hit rate shown in the advertising effect information. Note that, in the fifth embodiment, based on the visit to the store by the end user with the affiliate user, the advertisement transferring consideration is calculated by highly evaluating that the affiliate user introduces products or services related to the advertisement to the end user more precisely.

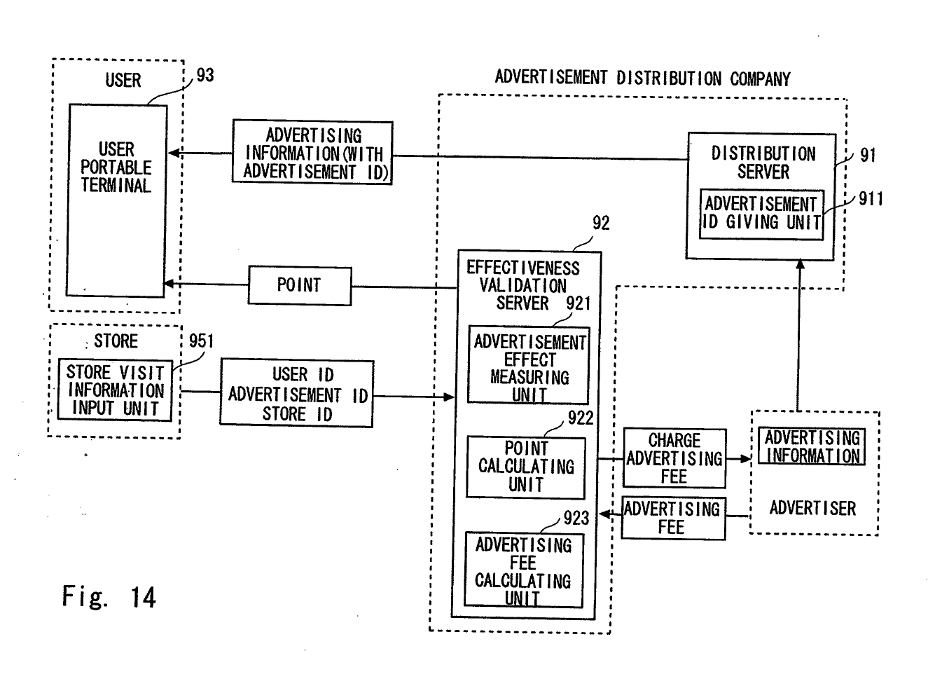

Next, the operation will be described. FIG. 13 is a flow chart showing a processing example in which the advertising distribution system according to the fifth embodiment distributes the advertising information and validates the advertising effectiveness. The processing of steps S501 to S503 in FIG. 13 is similar to that of steps S401 to S403 shown in the fourth embodiment.

The affiliate user checks the advertisement content displayed in the affiliate user terminals 51 and 52, transfers the advertising information to an acquaintance of the affiliate user, or the end user, that would like to have an interest in products or services shown in the advertisement, and visits the store with the end user.

The affiliate user terminals 51 and 52 detect the affiliate terminal position information at a predetermined timing in accordance with the processing similar to that of step S103 shown in the first embodiment, and judges whether the affiliate user has visited the store based on the advertisement position information added to the advertising information and the detected affiliate terminal position information (step S504). Upon judgment that the affiliate user has visited the store, the affiliate user terminals 51 and 52 extract the user ID stored in a storing unit such as a memory or the like in advance, and the advertisement ID and the affiliate ID added to the advertising information, and transmits the extracted IDs to the effectiveness validation server 2 through communication network (step S505).

The processing of steps S506 and S507 is similar to the processing of steps S404 and S405 shown in the fourth embodiment.

Next, the effectiveness validation server 2 judges whether the end user and the affiliate user have visited the store together based on the affiliate ID, the advertisement ID, and the user ID received from the affiliate user terminals 51 and 52, and the affiliate ID, the advertisement ID, and the user ID received from the user portable terminal 3 (step S508). Further, upon judgment that the end user and the affiliate user have visited the store together, the effectiveness validation server 2 adds one to the number of accompanying visits to the store for the affiliate user, and updates the number of accompanying visits to the store stored in the advertisement effect database 26D.

The processing of steps S509 and S510 is similar to that of steps S407 and S408 shown in the fourth embodiment.

Next, the effectiveness validation server 2 calculates the advertisement transferring consideration paid for the affiliate user for each affiliate user based on the advertising effect information stored in the advertisement effect database 26C (step S511). For example, the effectiveness validation server 2 calculates the advertisement transferring consideration paid for the affiliate user in accordance with the actual number of visits to the store and the hit rate shown in the advertising effect information as is similar to the fourth embodiment. Further, for example, the effectiveness validation server 2 calculates the advertisement transferring consideration by highly evaluating a point that the end user and the affiliate user have visited the store together according to the number of accompanying visits to the store shown in the advertising effect information. For example, the effectiveness validation server 2 calculates the advertisement transferring consideration so that the consideration paid when the end user visits the store with the affiliate user once becomes equal to the consideration when only the end user visits the store twice.

Then, the advertisement distribution company pays the calculated advertisement transferring consideration for the affiliate user. Note that, for example, the effectiveness validation server 2 may pay the advertisement transferring consideration using the electronic money or the like based on the calculated advertisement transferring consideration.

As described above, according to the fifth embodiment, it is possible to realize a business model in which the consideration is paid for the affiliate user by highly evaluating that the affiliate user and the end user have visited the store together compared with a case in which only the end user visits the store. Further, to realize the affiliate business, there is no need to perform special operation by a store personnel and to provide a store terminal such as a point card reader or the like in the store. Accordingly, the affiliate business can be realized without increasing the burden on the store side.

### INDUSTRIAL APPLICABILITY

The present invention may be applied to the specification of distributing the advertising information and providing the advertising distribution service in which the advertising fee is paid for the advertiser in accordance with the number of times that the user has actually visited the store in response to the advertising distribution. Further, the present invention may be applied to the specification of providing a service of affiliate distribution of the advertising information.

1. An advertising distribution system comprising:
an advertising effectiveness validation server that validates an advertising effectiveness; and
a user terminal, wherein
the user terminal comprises:
a terminal position calculating unit that obtains terminal position information indicating position of the user terminal;
a store visit judging unit that judges whether or not a user has visited a store on a basis of the terminal position information obtained by the terminal position calculating unit; and
a store visit information transmitting unit that transmits store visit information indicating that the user has visited the store to the advertising effectiveness validation server through communication network upon judgment by the store visit judging unit that the user has visited the store, the store visit information including position calculating unit identifying information that is capable of identifying the terminal position calculating unit
the advertising effectiveness validation server comprises:
an advertising effectiveness validating unit that validates the advertising effectiveness based on the store visit information received from the user terminal;
an improper convert information acquiring unit that acquires improperly converted terminal information indicating a user terminal which is improperly converted; and
a reliability judging unit that judges reliability of positional calculation using the terminal position calculating unit based on the position calculating unit identifying information and the improperly converted terminal information, and
the advertising effectiveness validating unit validates the advertising effectiveness based on judgment by the reliability judging unit that the reliability of the positional calculation using the terminal position calculating unit is high.

2. The advertising distribution system according to claim 1, wherein
the user terminal transmits at least one of position detection accuracy and resolution of the terminal position calculating unit to the advertising effectiveness validation server, and
the reliability judging unit judges the reliability of the positional calculation based on at least one of the position detection accuracy and the resolution.

3. The advertising distribution system according to claim 1, further comprising an advertisement distribution server that distributes advertising information, wherein
the advertisement distribution server comprises:
an advertisement position information adding unit that adds advertisement position information indicating position regarding advertising information to the advertising information; and
an advertising information transmitting unit that transmits advertising information to which the advertisement position information is added by the advertisement position information adding unit to the user terminal through communication network, and
the store visit judging unit judges whether the user has visited the store based on the terminal position information obtained by the terminal position calculating unit and the advertisement position information added to the advertising information received from the advertisement distribution server.

4. The advertising distribution system according to claim 3, wherein
the advertisement distribution server comprises an advertisement ID adding unit that adds an advertisement ID for identifying advertising information to the advertising information,
the advertising information transmitting unit transmits the advertising information to which the advertisement ID is added by the advertisement ID adding unit to the user terminal through communication network,
the store visit information transmitting unit transmits store visit information including the advertisement ID added to the advertising information received from the advertisement distribution server to the advertising effectiveness validation server through communication network,
the advertising effectiveness validating unit generates information including the number of customers visiting the store as advertising effect information indicating the advertising effectiveness by counting the number of times of reception of the advertisement ID from the user terminal, and
the advertising effectiveness validation server comprises an advertising fee calculating unit that calculates an advertising fee charged to an advertiser according to the number of customers visiting the store shown in the advertising effect information generated by the advertising effectiveness validating unit.

5. The advertising distribution system according to claim 1, wherein
the store visit information transmitting unit transmits store visit information including a user ID for identifying a user to the advertising effectiveness validation server through communication network,
the advertising effectiveness validating unit generates information including the number of visits to the store by the user as the advertising effect information indicating the advertising effectiveness by counting the number of times of reception of the user ID from the user terminal, and
the advertising effectiveness validation server comprises a point calculating unit that calculates a point given to the user in accordance with the number of visits to the store shown in the advertising effect information generated by the advertising effectiveness validating unit.

6. An advertising distribution system comprising:
an advertising effectiveness validation server that validates a advertising effectiveness;
a communication carrier server that is managed by a communication carrier; and
a user terminal, wherein
the user terminal comprises:
a terminal position calculating unit that obtains terminal position information indicating position of the user terminal;
a store visit judging unit that judges whether or not a user has visited a store on a basis of the terminal position information obtained by the terminal position calculating unit; and
a store visit information transmitting unit that transmits store visit information indicating that the user has visited the store to the advertising effectiveness validation server through communication network upon judgment by the store visit judging unit that the user has visited the store,
the advertising effectiveness validation server comprises an advertising effectiveness validating unit that validates the advertising effectiveness based on the store visit information received from the user terminal,
the communication carrier server comprises:
a terminal position acquiring unit that acquires the terminal position information;
a carrier-side store visit judging unit that judges whether the user has visited the store based on the terminal position information acquired by the terminal position acquiring unit; and
a carrier-side store visit information transmitting unit that transmits store visit information indicating that the user has visited the store to the advertising effectiveness validation server through communication network based on the judgment by the carrier-side store visit judging unit that the user has visited the store, and
the advertising effectiveness validation server comprises a carrier consideration calculating unit that calculates consideration paid for the communication carrier based on a result of validation by the advertising effectiveness validating unit.

7. The advertising distribution system according to claim 1, further comprising:
an advertisement distribution server that distributes advertising information; and
an affiliate terminal that is used by an affiliate mediator that mediates the advertising information, wherein
the advertisement distribution server comprises:
an affiliate ID adding unit that adds an affiliate ID for identifying the affiliate mediator to the advertising information; and
an advertising information transmitting unit that transmits the advertising information to which the affiliate ID is added by the affiliate ID adding unit to the user terminal through communication network,
the affiliate terminal comprises an advertising information transferring unit that transfers the advertising information received from the advertisement distribution server to the user terminal;
the store visit information transmitting unit transmits the store visit information including the affiliate ID added to the advertising information received from the affiliate terminal to the advertising effectiveness validation server through communication network,
the advertising effectiveness validating unit generates information including actual number of visits to the store by the user in response to introduction by the affiliate mediator as the advertising effect information indicating the advertising effectiveness by counting the number of times of reception of the affiliate ID from the user terminal; and
the advertising effectiveness validation server comprises an affiliate consideration calculating unit that calculates consideration paid for the affiliate mediator in accordance with the actual number of visits to the store shown in the advertising effect information generated by the advertising effectiveness validating unit.

8. The advertising distribution system according to claim 7, wherein
the affiliate terminal comprises:
an affiliate terminal position calculating unit that obtains affiliate terminal position information indicating position of the affiliate terminal;
an affiliate store visit judging unit that judges whether the affiliate mediator has visited the store based on the affiliate terminal position information obtained by the affiliate terminal position calculating unit, and
an affiliate store visit information transmitting unit that transmits the affiliate store visit information indicating that the affiliate mediator has visited the store to the advertising effectiveness validation server through communication network based on the judgment by the affiliate store visit judging unit that the affiliate mediator has visited the store,
the advertising effectiveness validation server comprises a company judging unit that judges whether the affiliate mediator and the user have visited the store together based on the affiliate terminal information received from the affiliate terminal and the store visit information received from the user terminal, and
the affiliate consideration calculating unit calculates consideration paid for the affiliate mediator based on a judgment result of the company judging unit.

9. An advertising effectiveness validation server comprising:
a position calculating unit identifying information receiving unit that receives store visit information including position calculating unit identifying information that is capable of identifying terminal position calculating unit used by a user terminal for calculating a position from the user terminal through communication network;
an improper convert information acquiring unit that acquires improper convert information indicating whether or not the user terminal is improperly converted;
a reliability judging unit that judges reliability of positional calculation using the terminal position calculating unit by the user terminal based on the position calculating unit identifying information and the improper convert information; and
an advertising effectiveness validating unit that validates the advertising effectiveness based on judgment by the reliability judging unit that the reliability of the position calculation with the terminal position calculating unit is high.

10. The advertising effectiveness validation server according to claim 9, wherein
the advertising effectiveness validation server receives at least one of resolution and position detection accuracy of the terminal position calculating unit from the user terminal, and
the reliability judging unit judges the reliability of the positional calculation using the terminal position calculating unit based on at least one of the position detection accuracy and the resolution.

11. The advertising effectiveness validation server according to claim 9, further comprising:
a carrier-side store visit information receiving unit that receives store visit information indicating that a user has visited a store from a communication carrier server managed by a communication carrier through communication network; and
a carrier consideration calculating unit that calculates consideration paid for the communication carrier based on a result of validation of the advertising effectiveness validating unit.

12. The advertising effectiveness validation server according to claim 9, further comprising a store visit information receiving unit that receives store visit information including an affiliate ID for identifying an affiliate mediator that mediates advertising information from the user terminal through communication network, wherein
the advertising effectiveness validating unit generates information including actual number of visits to the store by the user in response to introduction by the affiliate mediator as advertising effect information indicating the advertising effectiveness by counting the number of times of reception of the affiliate ID from the user terminal, and
the advertising effectiveness validation server further comprises an affiliate consideration calculating unit that calculates consideration paid for the affiliate mediator in accordance with the actual number of visits to the store shown in the advertising effect information generated by the advertising effectiveness validating unit.

13. The advertising effectiveness validation server according to claim 9, further comprising:
an affiliate store visit information receiving unit that receives affiliate store visit information indicating that the affiliate mediator has visited the store through communication network from an affiliate terminal used by the affiliate mediator; and
a company judging unit that judges whether the affiliate mediator and the user have visited the store together based on the store visit information received from the user terminal and affiliate terminal information received from the affiliate terminal, wherein
the affiliate consideration calculating unit calculates consideration paid for the affiliate mediator based on a judgment result by the company judging unit.

14. An advertising distribution method comprising:
a terminal position calculating step that obtains terminal position information indicating position of a user terminal by the user terminal;
a store visit judging step that judges by the user terminal whether a user has visited a store on a basis of the terminal position information that is obtained;
a store visit information transmitting step that transmits store visit information by the user terminal to an advertising effectiveness validation server through communication network upon judgment that the user has visited the store, the store visit information including position calculating unit identifying information that is capable of identifying a terminal position calculating unit used by the user terminal for calculating the position;
an improper convert information acquiring step in which the advertising effectiveness validation server acquires improper convert information indicating whether or not the user terminal is improperly converted; and
a reliability judging step in which the advertising effectiveness validation server judges reliability of positional calculation using the terminal position calculating unit based on the improper convert information and the position calculating unit identifying information, wherein
the advertising effectiveness validation server validates the advertising effectiveness based on judgment in the advertising effectiveness validating step that the reliability of the positional calculation using the terminal position calculating unit is high.

15. The advertising distribution method according to claim 14, further comprising:
a position detection accuracy and resolution acquiring step in which the advertising effectiveness validation server receives at least one of resolution and position detection accuracy of the position calculating unit from the user terminal, wherein
the advertising effectiveness validation server judges the reliability of the positional calculation using the terminal position calculating unit based on at least one of the position detection accuracy and the resolution in the reliability judging step.

16. The advertising distribution method according to claim 14, further comprising:
a terminal position acquiring step in which a communication carrier server managed by a communication carrier acquires the terminal position information;
a carrier-side store visit judging step in which the communication carrier server judges whether the user has visited the store based on the terminal position information that is acquired;
a carrier-side store visit information transmitting step in which the communication carrier server transmits store visit information indicating visit of the user to the advertising effectiveness validation server through communication network based on the judgment that the user has visited the store; and
a carrier consideration calculating step in which the advertising effectiveness validation server calculates consideration paid for the communication carrier based on a result of validation of the advertising effectiveness.

17. The advertising distribution method according to claim 14, further comprising:
an affiliate ID adding step in which an advertisement distribution server distributing advertising information adds an affiliate ID for identifying an affiliate mediator that mediates the advertising information to advertising information;
an advertising information transmitting step in which the advertisement distribution server transmits the advertising information to which the affiliate ID is added to the user terminal through communication network;
an advertising information transferring step in which an affiliate terminal used by the affiliate mediator transfers the advertising information received from the advertisement distribution server to the user terminal, wherein
the user terminal transmits the store visit information including the affiliate ID added to the advertising information received from the affiliate terminal to the advertising effectiveness validation server through communication network in the store visit information transmitting step, and
the advertising effectiveness validation server generates information including actual number of visits to the store by the user in response to introduction by the affiliate mediator as the advertising effect information indicating the advertising effectiveness by counting the number of times of reception of the affiliate ID from the user terminal in the advertising effectiveness validating step, the advertising distribution method further comprising:
an affiliate consideration calculating step in which the advertising effectiveness validation server calculates consideration paid for the affiliate mediator in accordance with the actual number of visits to the store shown in the advertising effect information that is generated.

18. The advertising distribution method according to claim 17, further comprising:
an affiliate terminal position calculating step in which the affiliate terminal obtains affiliate terminal position information indicating position of the affiliate terminal;
an affiliate store visit judging step in which the affiliate terminal judges based on the obtained affiliate terminal position information whether the affiliate mediator has visited the store;
an affiliate store visit information transmitting step in which the affiliate terminal transmits affiliate store visit information indicating the visit of the affiliate mediator to the advertising effectiveness validation server through communication network based on the judgment that the affiliate mediator has visited the store; and
a company judging step in which the advertising effectiveness validation server judges based on the store visit information received from the user terminal and the affiliate terminal information received from the affiliate terminal whether the affiliate mediator and the user have visited the store together, wherein
the advertising effectiveness validation server calculates consideration paid for the affiliate mediator based on a judgment result whether the user and the affiliate mediator have visited together in the affiliate consideration calculating step.

19. A computer-readable medium storing an advertising effectiveness validation program product that validates advertising effectiveness in an advertising distribution system that distributes advertising information, the program product causing a computer to implement:
a position calculating unit identifying information reception processing that receives store visit information including position calculating unit identifying information that is capable of identifying terminal position calculating unit used by a user terminal for calculating position from the user terminal through communication network;
an improper convert information acquisition processing that acquires improper convert information indicating whether or not the user terminal is improperly converted;
a reliability judgment processing that judges reliability of positional calculation using the terminal position calculating unit by the user terminal based on the position calculating unit identifying information that is received and the improper convert information that is acquired; and
an advertising effectiveness validation processing that validates the advertising effectiveness based on judgment that the reliability of the positional calculation using the terminal position calculating unit is high.

20. The computer-readable medium storing the advertising effectiveness validation program product according to claim 19, further comprising a position detection accuracy and resolution acquisition processing that acquires at least one of resolution and position detection accuracy of the terminal position calculating unit from the user terminal, and
the reliability judgment processing judges the reliability of the positional calculation using the terminal position calculating unit based on at least one of the position detection accuracy and the resolution.

21. The computer-readable medium storing the advertising effectiveness validation program product according to claim 19, the program product causing the computer to implement:
a carrier-side store visit information reception processing that receives store visit information indicating visit of the user from a communication carrier server managed by a communication carrier through communication network; and
a carrier consideration calculation processing that calculates consideration paid for the communication carrier based on a result of validation of the advertising effectiveness.

22. The computer-readable medium storing the advertising effectiveness validation program product according to claim 19, the program product causing the computer to implement:
a store visit information reception processing that receives store visit information including an affiliate ID for identifying an affiliate mediator that mediates advertising information from the user terminal through communication network;
a processing that generates information including actual number of visits to the store by the user in response to introduction by the affiliate mediator as advertising effect information indicating the advertising effectiveness by counting the number of times of reception of the affiliate ID from the user terminal in the advertising effectiveness validation processing; and
an affiliate consideration calculation processing that calculates consideration paid for the affiliate mediator in accordance with the actual number of visits to the store shown in the advertising effect information that is generated.

23. The computer-readable medium storing the advertising effectiveness validation program product according to claim 22, the program product causing the computer to implement:
an affiliate store visit information reception processing that receives affiliate store visit information indicating the visit of the affiliate mediator from an affiliate terminal used by the affiliate mediator through communication network;
a company judgment processing that judges based on the store visit information received from the user terminal and affiliate terminal information received from the affiliate terminal whether the affiliate mediator and the user have visited the store together; and
a processing that calculates consideration paid for the affiliate mediator based on a judgment result whether the user and the affiliate mediator have visited the store together in the affiliate consideration calculation processing.

24. The advertising distribution system according to claim 6, further comprising:
an advertisement distribution server that distributes advertising information; and
an affiliate terminal that is used by an affiliate mediator that mediates the advertising information, wherein
the advertisement distribution server comprises:
an affiliate ID adding unit that adds an affiliate ID for identifying the affiliate mediator to the advertising information; and
an advertising information transmitting unit that transmits the advertising information to which the affiliate ID is added by the affiliate ID adding unit to the user terminal through communication network,
the affiliate terminal comprises an advertising information transferring unit that transfers the advertising information received from the advertisement distribution server to the user terminal;
the store visit information transmitting unit transmits the store visit information including the affiliate ID added to the advertising information received from the affiliate terminal to the advertising effectiveness validation server through communication network,
the advertising effectiveness validating unit generates information including actual number of visits to the store by the user in response to introduction by the affiliate mediator as the advertising effect information indicating the advertising effectiveness by counting the number of times of reception of the affiliate ID from the user terminal; and
the advertising effectiveness validation server comprises an affiliate consideration calculating unit that calculates consideration paid for the affiliate mediator in accordance with the actual number of visits to the store shown in the advertising effect information generated by the advertising effectiveness validating unit.
